(19) United States
(12) Patent Application Publication
(10) Pub. No.: US 2017/0293959 A1
(43) Pub. Date: Oct. 12, 2017

(54) INFORMATION PROCESSING APPARATUS, SHELF LABEL MANAGEMENT SYSTEM, CONTROL METHOD, AND PROGRAM

(71) Applicant: NEC Corporation, Minato-ku, Tokyo (JP)

(72) Inventors: Yoshihiro ITOU, Tokyo (JP); Kanako TAGA, Tokyo (JP); Takenobu KITAHARA, Tokyo (JP)

(73) Assignee: NEC Corporation, Minato-ku, Tokyo (JP)

(21) Appl. No.: 15/508,556

(22) PCT Filed: Sep. 28, 2015
(86) PCT No.: PCT/JP2015/077264

§ 371 Date: Mar. 3, 2017

(30) Foreign Application Priority Data
Sep. 30, 2014 (JP) 2014-201365

(51) Int. Cl. G06Q 30/06; G06T 7/73; A47F 5/00

(52) U.S. Cl. CPC G06Q 30/0623; A47F 5/0043; G06T 7/73; G06K 7/10861

(57) ABSTRACT

A product recognition unit (2020) recognizes a product from a target image on which the product and an electronic shelf label are imaged. A shelf label recognition unit (2040) extracts a shelf label ID from the target image. The shelf label recognition unit (2040) recognizes an electronic shelf label (3000) from the target image. A determination unit (2060) determines whether or not association of product information and the shelf label ID regarding the product and the electronic shelf label a closest product within the image, and product information and the shelf label ID of the electronic shelf label (3000) matches association of product information and a shelf label ID of relation information acquired by associating product information of the product and the shelf label ID based on the product and shelf label ID recognized from the target image.

### TECHNICAL FIELD

The present invention relates to an information processing apparatus, a shelf label management system, a control method, and a program.

### BACKGROUND ART

On a product shelving in a store, there is a shelf label near a product that describes information such as a name or price of the product (hereinafter, referred to as product information). In recent years, an electronic shelf label that displays product information on a small liquid crystal display is used. A system using the electronic shelf label is developed.

Patent Document 1 discloses a system that performs: in a situation in which a shelf label displaying product information and shelf label identification information is attached to product shelving, imaging the shelf label identification information of each shelf label with a camera; recognizing the imaged shelf label; and managing the shelf label. Specifically, this system generates a map representing a position of each shelf label, or detects the shelf label expiration date for use of which has been expired and reports the detected shelf label.

### RELATED DOCUMENT

### Patent Document

[Patent Document 1] Japanese Patent Application Publication No. 2014-48752

### SUMMARY OF THE INVENTION

### Technical Problem

If the product and the electronic shelf label are not correctly associated with each other, it causes a problem that a customer is not able to appropriately recognize the price of the product. For example, such a problem occurs in a case where the products to be exhibited are changed and therefore the exhibited product and product information displayed by the electronic shelf label disposed near the product becomes inconsistent with each other. In addition, it may causes a situation in which an exhibited product does not have a corresponding electronic shelf label that is to display the product information of this exhibited product. In the system of Patent Document 1, a technique for managing whether or not the product and the electronic shelf label are correctly associated with each other is not disclosed.

The invention has been made in view of the aforementioned problems. An object of the present invention is to provide a technique for supporting the management of electronic shelf labels.

### Solution to Problem

An information processing apparatus provided by the present invention includes: a product recognition unit that recognizes a product from an image on which the product and an electronic shelf label are imaged; a shelf label recognition unit that extracts a shelf label ID of the electronic shelf label from the image, and recognizes a position of the electronic shelf label; and a determination unit that determines whether or not association of a closest product within the image, and product information and the shelf label ID of the electronic shelf label matches association of product information and a shelf label ID of relation information acquired by associating product information of the product and the shelf label ID based on the recognized product and shelf label ID.

A shelf label management system provided by the present invention includes the information processing apparatus provided by the present invention and an electronic shelf label. The electronic shelf label includes a display unit that displays the product information associated with the shelf label ID of the electronic shelf label.

A control method provided by the present invention is performed by a computer. The control method includes: a product recognition step of recognizing a product from an image on which the product and an electronic shelf label are imaged; a shelf label recognition step of extracting a shelf label ID of the electronic shelf label from the image, and recognizing a position of the electronic shelf label; and a determination step of determining whether or not association of a closest product within the image, and product information and the shelf label ID of the electronic shelf label matches association of product information and a shelf label ID of relation information acquired by associating product information of the product and the shelf label ID based on the recognized product and shelf label ID.

A program provided by the present invention causes a computer to have a function of operating as the information processing apparatus provided by the present invention.

### Advantageous Effects of Invention

According to the present invention, a technique for supporting the management of electronic shelf labels is provided.

### BRIEF DESCRIPTION OF THE DRAWINGS

The above objects, other objects, advantages and features will be more apparent from the following description of certain preferred embodiments taken in conjunction with the accompanying drawings.

FIG. 1 is a block diagram illustrating an information processing apparatus according to Exemplary Embodiment 1 and a usage environment thereof.

FIG. 2 is a flowchart illustrating a flow of processes performed by the information processing apparatus of Exemplary Embodiment 1.

FIG. 3 is a block diagram illustrating a hardware configuration of a computer that realizes the information processing apparatus.

FIG. 4 is a diagram illustrating a target image.

FIG. 5 is a diagram illustrating product information including a feature value in a table format.

FIG. 6 is a diagram illustrating a predetermined area in which a shelf label ID is displayed.

FIG. 7 is a diagram illustrating an electronic shelf label that may be in two states.

FIG. 8 is a diagram illustrating relation information in a table format.

FIG. 9 is a diagram illustrating a distance between a product and an electronic shelf label.

FIG. 10 is a diagram illustrating a case where the arrangement of Products AAA and BBB on the target image of FIG. 4 is changed.

FIG. 11 is a block diagram illustrating an information processing apparatus according to Exemplary Embodiment 2.

FIG. 12 is a diagram illustrating a determination result output by a first output unit in a table format.

FIG. 13 is a flowchart illustrating a flow of processes performed by the information processing apparatus of Exemplary Embodiment 2.

FIG. 14 is a block diagram illustrating the information processing apparatus according to Exemplary Embodiment 3 and a usage environment thereof.

FIG. 15 is a flowchart illustrating a flow of processes performed by the information processing apparatus of Exemplary Embodiment 3.

FIG. 16 is a block diagram illustrating an information processing apparatus according to Exemplary Embodiment 4 and a usage environment thereof.

FIG. 17 is a flowchart illustrating a flow of processes performed by the information processing apparatus of Exemplary Embodiment 4.

FIG. 18 is a diagram illustrating a situation in which the same electronic shelf label is closest from each of the plurality of different products.

FIG. 19 is a diagram illustrating a case where the electronic shelf label simultaneously displays two pieces of product information.

FIG. 20 is a diagram illustrating a case where the electronic shelf label displays three pieces of product information in a time-division manner.

FIG. 21 is a block diagram illustrating an information processing apparatus of Exemplary Embodiment 5 and a usage environment thereof.

FIG. 22 is a flowchart illustrating a flow of processes performed by the information processing apparatus of Exemplary Embodiment 5.

FIG. 23 is a block diagram illustrating an information processing apparatus of Exemplary Embodiment 6 and a usage environment thereof.

FIG. 24 is a diagram illustrating a case where relation information that has been changed is displayed on the target image.

FIG. 25 is a flowchart illustrating a flow of processes performed by the information processing apparatus of Exemplary Embodiment 6.

FIG. 26 is a block diagram illustrating an information processing apparatus of Exemplary Embodiment 7 and a usage environment thereof.

FIG. 27 is a flowchart illustrating a flow of processes performed by the information processing apparatus of Exemplary Embodiment 7.

### DESCRIPTION OF EMBODIMENTS

Hereinafter, exemplary embodiments of the present invention will be described with reference to the drawings. In all the drawings, the same components will be assigned the same reference numerals, and the description thereof will not be appropriately repeated.

### Exemplary Embodiment 1

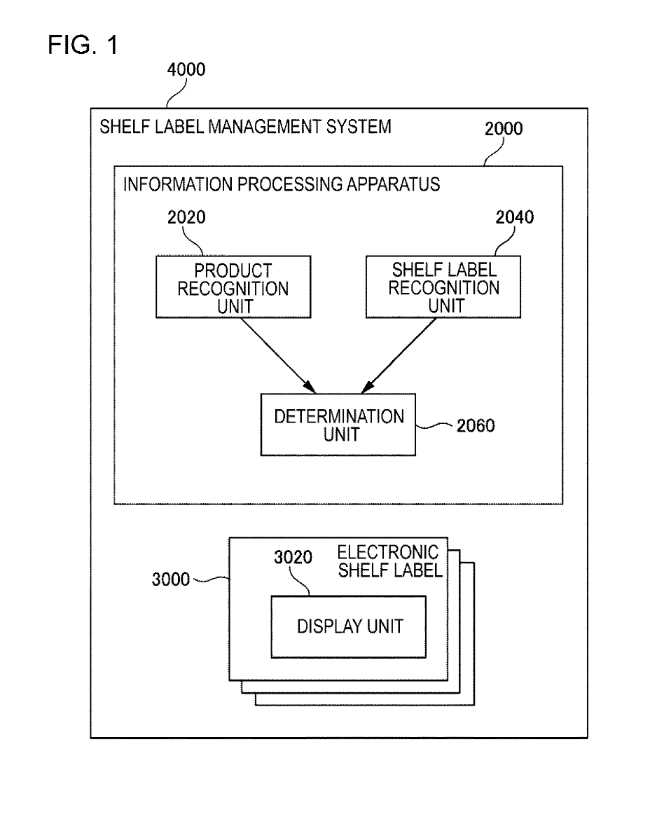

FIG. 1 is a block diagram illustrating an information processing apparatus 2000 according to Exemplary Embodiment 1 and a usage environment thereof. In FIG. 1, arrows represent information flows. In FIG. 1, each block depicts not a configuration of a hardware unit but a configuration of a functional unit.

A shelf label management system 4000 includes the information processing apparatus 2000 and an electronic shelf label 3000. The electronic shelf label 3000 is a shelf label provided in the vicinity of a product (on a shelf plate of product shelving, or the like), and displays product information. The product information displayed by the electronic shelf label 3000 is, for example, a product name or price. The electronic shelf label 3000 includes a display unit 3020 that displays these pieces of information. For example, the display unit 3020 is a liquid crystal display.

The information processing apparatus 2000 includes a product recognition unit 2020, a shelf label recognition unit 2040, and a determination unit 2060. The information processing apparatus 2000 uses relation information. The relation information associates product information of the product with a shelf label ID of the electronic shelf label 3000.

The product recognition unit 2020 recognizes a product from an image on which a product and an electronic shelf label are imaged (hereinafter, referred to as a target image). The shelf label recognition unit 2040 extracts the shelf label ID of the electronic shelf label 3000 from the target image. The shelf label recognition unit 2040 recognizes a position of the electronic shelf label 3000 from the target image. The determination unit 2060 determines whether or not the association of the product information and the shelf label ID regarding the product and the shelf label 3000 that are closest to each other within the target image matches the association of the product information and the shelf label ID indicated by the relation information, based on the product and the shelf label ID recognized from the target image. In other words, the determination unit 2060 determines whether or not “a combination of the product information and the shelf label ID” regarding the product and the shelf label 3000 that are closest to each other within the target image matches “a combination of the product information and the shelf label ID” indicated by the relation information. Here, the product information includes a product ID, with which the product is identified.

<Flow of Processes>

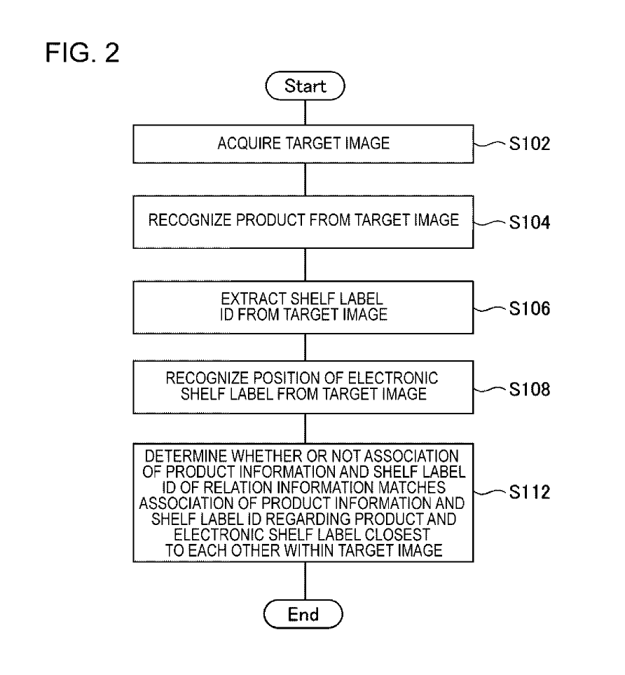

FIG. 2 is a flowchart illustrating a flow of processes performed by the information processing apparatus 2000 of Exemplary Embodiment 1. The information processing apparatus 2000 acquires the target image (S102). The product recognition unit 2020 recognizes the product from the target image (S104). The shelf label recognition unit 2040 extracts the shelf label ID of the electronic shelf label 3000 from the target image (S106). The shelf label recognition unit 2040 recognizes the position of the electronic shelf label 3000 from the target image (S108). The determination unit 2060 determines whether or not the association of the product information and the shelf label ID indicated by the relation information matches the association of the product information and the shelf label ID regarding the product and the shelf label 3000 that are closest to each other within the target image matches (S112).

According to the information processing apparatus 2000 of the exemplary embodiment, the aforementioned determination is performed on the content of the acquired relation information. Specifically, it is determined whether or not the association of the product information and the shelf label ID indicated by the relation information matches the association of the product information and the shelf label ID regarding the product and the shelf label 3000 that are closest to each other within the target image. Accordingly, it is possible to detect that the association of the product information and the shelf label ID indicated by the relation information does not match the association of the product information and the shelf label ID regarding the product and the shelf label 3000 that are closest to each other within the target image matches. For example, the non-matching is detected in a case where the relation information indicates a combination of “product information of Product A and shelf label ID of Shelf Label X” whereas the product closest to Shelf Label X within the corresponding image is Product B.

Here, the electronic shelf label 3000 is configured to display the product information in advance that is associated with this electronic shelf label 3000 by the relation information. By doing so, it is possible to determine whether or not the product information displayed by the electronic shelf label 3000 is product information of the product closest to this electronic shelf label 3000. As a result, it is possible to detect the electronic shelf label 3000 that does not display the product information to be displayed. By using the information processing apparatus 2000 as stated above, since a salesperson does not need to manually check whether or not the association of the product with the electronic shelf label 3000 is correct, workload for managing the electronic shelf label 3000 is reduced. Therefore, according to the information processing apparatus 2000, it is possible to reduce effort, time, and cost necessary to manage the electronic shelf label 3000.

Note that, according to the information processing apparatus 2000 of the present exemplary embodiment, in a case where a plurality of different products and a plurality of different electronic shelf labels 3000 are pictured on the target image, the determination is automatically performed for each of a plurality of pieces of relation information. Thus, it is not necessary to check whether or not the association of the electronic shelf label 3000 with the product is correct for each pairs of the electronic shelf label and the product one by one. From this point of view, the workload of the salesperson is further reduced.

Hereinafter, the information processing apparatus 2000 of the present exemplary embodiment will be described in more detail.

<Hardware Configuration Example>

The respective functional components of the information processing apparatus 2000 may be realized by hardware (for example, a hard-wired electronic circuit) that realizes each functional component, or may be realized by a combination (for example, a combination of an electronic circuit and a program that controls the electronic circuit) of hardware and software. Hereinafter, in a case where each functional component is realized by the combination of hardware and software, the configuration thereof will be illustrated in detail.

The information processing apparatus 2000 is realized by various types of computers, such as a portable terminal, a personal computer (PC), or a server. Here, the information processing apparatus 2000 may be realized by a dedicated computer for implementing the information processing apparatus 2000, or may be realized by a general-purpose computer that operates other applications.

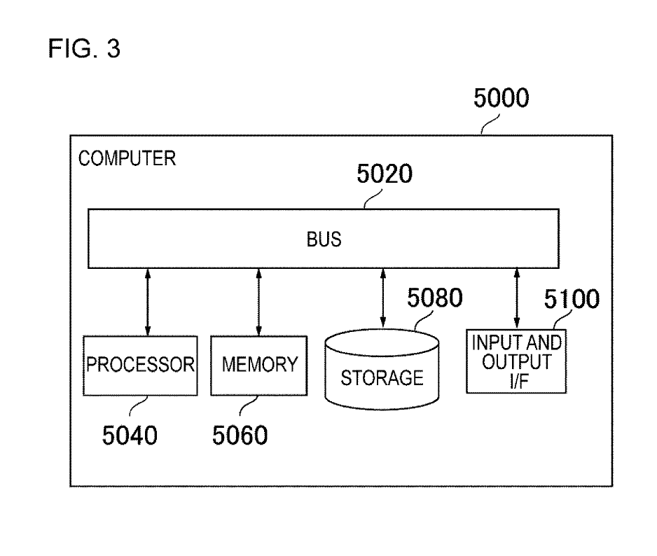

FIG. 3 is a block diagram illustrating a hardware configuration of a computer 5000 that realizes the information processing apparatus 2000. The computer 5000 includes a bus 5020, a processor 5040, a memory 5060, a storage 5080, and an input and output interface 5100. The bus 5020 is a data transmission path through which the processor 5040, the memory 5060, the storage 5080, and the input and output interface 5100 transmit and receive data to and from one another. Here, the method of connecting the processor 5040 and the like is not limited to bus connection. The processor 5040 is, for example, an arithmetic processing device such as a central processing unit (CPU) or a graphics processing unit (GPU). The memory 5060 is, for example, a memory such as a random access memory (RAM) or a read only memory (ROM). The storage 5080 is, for example, a storage apparatus such as a hard disk, a solid state drive (SSD), or a memory card. The storage 5080 may be a memory such as RAM or ROM.

The input and output interface 5100 is an input and output interface through which the computer 5000 transmits and receives data to and from an external apparatus. For example, in a case where the information processing apparatus 2000 acquires the target image or the relation information from the external apparatus, the computer 5000 that realizes the information processing apparatus 2000 is connected to the external apparatus through the input and output interface 5100. Note that, there are various methods of connecting the computer 5000 to the external apparatus through the input and output interface. For example, such connection is bus connection using a bus line (for example, universal serial bus (USB)) or network connection using a network line. Note that the network line may be a wireless line, or may be a wired line.

The storage 5080 stores a program for realizing the function of the information processing apparatus 2000. Specifically, program modules for respectively realizing the functions of the product recognition unit 2020, the shelf label recognition unit 2040, and the determination unit 2060 are stored. The processor 5040 realizes the functions of the product recognition unit 2020, the shelf label recognition unit 2040, and the determination unit 2060 by executing the respective program modules. Here, when the respective modules are executed, the processor 5040 may read these modules into the memory 5060 and may execute the read module, or may execute the module without reading the module into the memory 5060.

Note that, the hardware configuration of the computer 5000 used for realizing the information processing apparatus 2000 is not limited to the configuration illustrated in FIG. 3. For example, the respective program module may be stored in the memory 5060. In this case, the computer 5000 may not include the storage 5080.

<Acquisition Method of Target Image>

The target image is imaged by a camera provided in a store. On one target image, only one type of product may be pictured or a plurality of different products may be pictured.

For example, the information processing apparatus 2000 acquires the target image stored within this camera. In a case where an external storage apparatus stores the target image generated by the camera, the information processing apparatus 2000 may acquired the target image from this storage apparatus. The camera may be provided such that the generated target image is stored in a storage apparatus provided within the information processing apparatus 2000. In this case, the information processing apparatus 2000 acquires the target image from a storage unit provided within the information processing apparatus 2000.

The camera may be provided integrally with the computer that realizes the information processing apparatus 2000, or may be provided outside the computer. As an example in which the camera is provided integrally with the computer that realizes the information processing apparatus 2000, the information processing apparatus 2000 may be realized as a portable terminal equipped with the camera. In this case, the information processing apparatus 2000 performs a process on a target image generated by the camera of the portable terminal.

<Details of Product Recognition Unit 2020>

<<Method of Recognizing Product 40>>

The product recognition unit 2020 analyzes a target image 10, and recognizes the product. Here, a technique for recognizing an object such as the product pictured on an image is a known technique, and various known techniques may be used for recognizing the object. Hereinafter, an example of a process performed by the product recognition unit 2020 will be described.

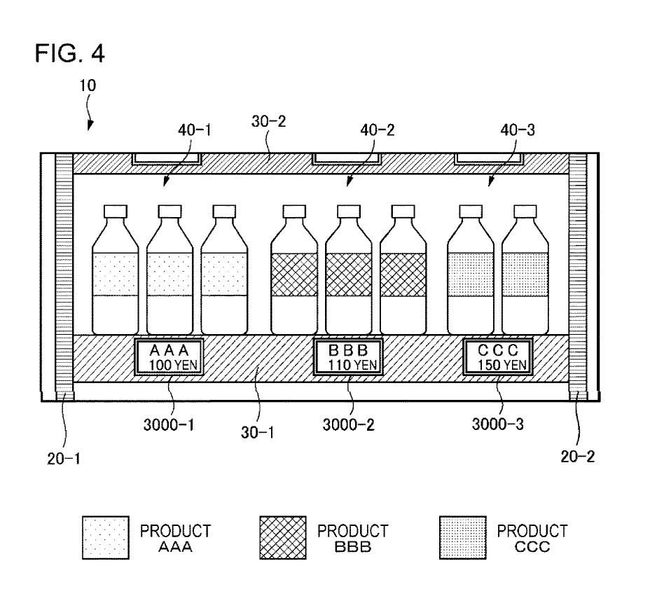

FIG. 4 is a diagram illustrating the target image 10. Product shelving on which the products are exhibited is pictured on the target image 10. Note that, an exhibition method of the products is not limited to a method of exhibiting the products on the product shelving, as long as the products and the electronic shelf labels 3000 are pictured on the target image.

An outer frame 20 is an outer frame of the product shelving. A shelf plate 30 is a plate on which the products are placed. The product 40 represents products. Three different products of a product 40-1, a product 40-2, and a product 40-3 are pictured on the target image 10. The product 40-1 is Product AAA, the product 40-2 is Product BBB, and the product 40-3 is Product CCC. Three electronic shelf labels 3000 are pictured on the target image 10.

The product recognition unit 2020 recognizes each product by using information associating the product with a feature value indicating an appearance feature thereof. For example, this information is included in the aforementioned product information. Here, the product information may be stored in advance in the storage unit provided inside or outside the information processing apparatus 2000. The product recognition unit 2020 acquires the product information from this storage unit.

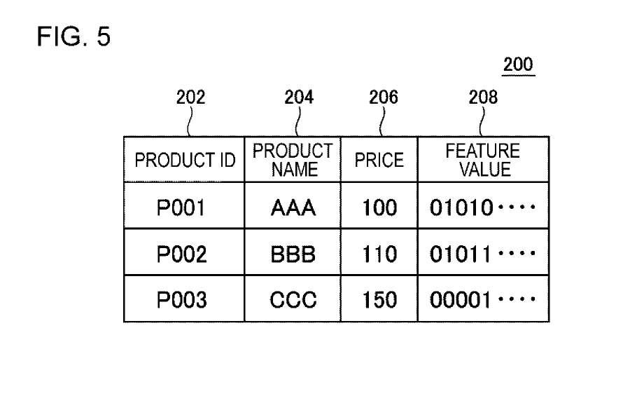

FIG. 5 is a diagram illustrating the product information including the feature value in a table format. The table illustrated in FIG. 4 will be described as a product information table 200. The product information table 200 includes four columns of a product ID 202, a product name 204, a price 206, and a feature value 208. The product ID 202 is an ID of the product. The product name 204 represents a product name. The price 206 represents the price of the product. The feature value 208 is a value representing the appearance feature of the product.

Specifically, the product recognition unit 2020 extracts an area representing the product (product area) from the target image 10. The product recognition unit 2020 acquires the product information the feature value 208 of which indicates the feature value equal or similar to the feature value of the extracted product area. The product recognition unit 2020 recognizes that the product represented by the extracted product area is the product identified by the product ID indicated by the acquired product information. The product recognition unit 2020 determines the product ID of the product represented by each product area by performing the aforementioned process for each product area.

Note that, as for the product information, a plurality of feature values may be associated with one product. In this case, these feature values are, for example, feature values indicating the features of the product viewed in different directions. In some products, the appearance of the product looks very different depending on directions in which the product is viewed. For example, there may be a product the patterns of the labels of which looks very different between in a case where the products are viewed in a certain direction and in a case where the product is viewed in another direction. Since the exhibited products are not necessarily exhibited as facing in the same direction, as for the product the appearance of which looks very different depending on the directions in which the product is viewed, the feature values of the product extracted from the target image may be different even though the same product is imaged.

Thus, the product recognition unit 2020 acquires the product information, at least one of the feature values among the plurality of the feature values 208 of which is equal or similar to the feature value of the product area extracted from the target image 10. The product recognition unit 2020 recognizes that the product represented by the product area is the product identified by the acquired product information. Through such processes, for example, even in a case where the products the appearances of which look very different depending on the directions in which the products are viewed are exhibited as facing in an arbitrary direction, it is possible to correctly recognize the products pictured on the target image.

<<Method of Recognizing Position of Product 40>>

For example, the product recognition unit 2020 recognizes a coordinate on the target image 10 of the area representing a group of the same products 40 being adjacent to each other (hereinafter, referred to as a product group area), as a position of this product 40. Note that, the number of products included in the product group area may be one.

The coordinate of the product group area is a coordinate indicating a predetermined location within the product group area. For example, this predetermined location is a center, a left end, or a right end of an area indicating the product group area. It is set for the product recognition unit 2020 in advance which portion of the product area is handled as the pre-determined location. Note that, the product recognition unit 2020 may recognize a plurality of positions of the product 40. Specifically, the product recognition unit recognizes a position of the left end, a position of the center, or a position of the right end of the product group area of each product 40. Note that, the product recognition unit 2020 may represent the position of the product 40 as a two-dimensional coordinate (a combination of a coordinate in a horizontal direction with a coordinate in a vertical direction), or may represent the position thereof as a one-dimensional coordinate (a coordinate in the horizontal direction).

<Details of Shelf Label Recognition Unit 2040>

<<Extraction Method of Shelf Label ID>>

The shelf label recognition unit 2040 analyzes the target image, and extracts the ID of the electronic shelf label 3000. Here, the shelf label ID for identifying the electronic shelf label 3000 is displayed on the electronic shelf label 3000. The shelf label recognition unit 2040 extracts the shelf label ID of the electronic shelf label 3000 displayed by the electronic shelf label 3000.

Initially, the shelf label recognition unit 2040 extracts an area (hereinafter, referred to as a shelf label area) representing the electronic shelf label 3000 from the target image. Here, the process of extracting the shelf label area from the target image may be realized by an existing technique of object recognition like the process of extracting the product area from the target image. For example, the shelf label recognition unit 2040 recognizes the area representing the shelf plate, and recognizes an object having a predetermined shape (a rectangle or the like) included in this area, as the electronic shelf label 3000. Here, the predetermined shape representing the electronic shelf label 3000 may be set in advance for the shelf label recognition unit 2040, or may be stored in the storage unit inside or outside the information processing apparatus 2000.

The shelf label recognition unit 2040 extracts the area representing the shelf label ID from the shelf label area. The shelf label recognition unit 2040 acquires the shelf label ID by analyzing this area.

Here, the process of acquiring the shelf label ID by analyzing the area representing the shelf label is different depending on a display format of the shelf label ID. For example, the shelf label ID displayed on the electronic shelf label 3000 may be a character string that directly represents the shelf label ID, another character string converted from the shelf label ID, or a figure such as a two-dimensional code or a barcode converted from the shelf label ID. Note that, the “another character sting converted from the shelf label ID” is, for example, a character string acquired by encrypting the shelf label ID.

In a case where the shelf label ID is displayed by a character string, the shelf label recognition unit 2040 acquires a character string displayed on the electronic shelf label 3000 by performing character string analysis on the area representing the shelf label ID. Here, in a case where the character string displayed on the electronic shelf label 3000 represents directly the shelf label ID, the shelf label recognition unit 2040 uses the acquired character string as the shelf label ID. On the other hand, in a case where the character string displayed on the electronic shelf label 3000 is the character string converted from the shelf label ID, the shelf label recognition unit 2040 calculates the shelf label ID by performing a predetermined reverse-conversion process on the acquired character string. The predetermined reverse-conversion process is a process of decoding the encoded character string. The content of the predetermined reverse-conversion process may be set for the shelf label recognition unit 2040 in advance, or may be stored in the storage unit inside or outside the information processing apparatus 2000 in advance.

In a case where the shelf label ID is displayed by the figure such as the aforementioned two-dimensional code, the shelf label recognition unit 2040 extracts the figure from the target image. The shelf label recognition unit 2040 calculates the shelf label ID from the extracted figure. Here, the technique for calculating a value represented by the figure from the figure such as the two-dimensional code or the barcode is a well-known technique, and thus, the description thereof will not be repeated.

<<Method for Distinguishing Display from Another Display>>

Here, in some cases, something other than the character string representing the shelf label ID may also be displayed on the electronic shelf label 3000. For example, in some cases, a product name or price may be previously displayed on the electronic shelf label 3000. In such a case, a location of the electronic shelf label 3000 in which the shelf label ID will be displayed may be defined in advance.

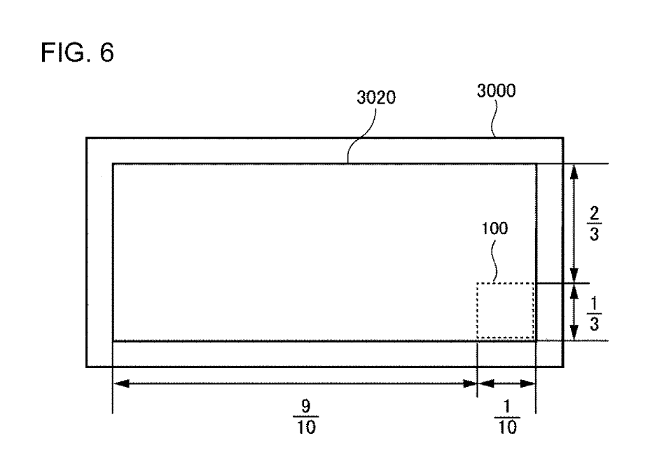

FIG. 6 is a diagram illustrating a predetermined area in which the shelf label ID is displayed. In FIG. 6, a horizontal range of an area 100 displaying the shelf label ID is “a range between the right end and a position distant from the right end by a distance of a tenth shorter than a long side of the electronic shelf label 3000”. A vertical range of the area displaying the shelf label ID is “a range between the lower end and a position distant from the lower end by a distance of a third shorter than a short side of the electronic shelf label 3000”. In this case, the shelf label recognition unit 2040 extracts the shelf label ID by extracting the area 100 of the electronic shelf label 3000 from the target image.

The electronic shelf label 3000 may be configured so as to be able to become in 1) a state in which the product information is displayed and 2) in a state in which the shelf label ID of the electronic shelf label 3000 is displayed. Here, the state in which the product information is displayed is referred to as a first mode, and the state in which the shelf label ID is displayed is referred to as a second mode.

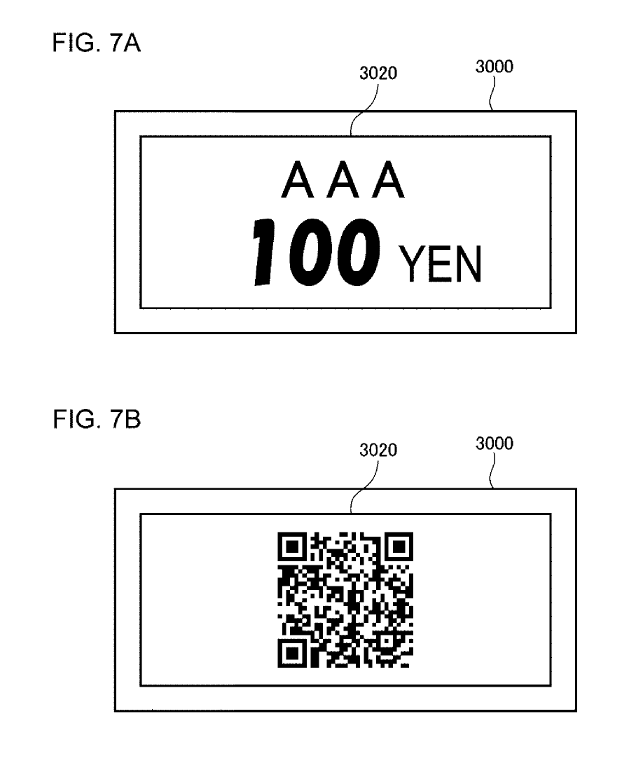

FIG. 7 are diagrams illustrating the electronic shelf label 3000 that may be in two states. FIG. 7A is a diagram illustrating the electronic shelf label 3000 in the first mode. In this diagram, the display unit 3020 displays the product name and price. On the other hand, FIG. 7B is a diagram illustrating the electronic shelf label 3000 in the second mode. In this diagram, the display unit 3020 displays the two-dimensional code representing the shelf label ID.

The information processing apparatus 2000 uses the target image on which the electronic shelf label 3000 in the second mode is imaged. By doing so, unnecessary character strings are not displayed on the display unit 3020, and it therefore makes easy the extraction process of the shelf label ID performed by the shelf label recognition unit 2040. The shelf label ID is able to be displayed with a larger size than that in a case where the product information is always displayed on the display unit 3020. Thus, it is possible to suppress a resolution required for the camera that images the target image. In addition, the product information is able to be displayed with a larger size than that in a case where the shelf label ID is always displayed on the display unit 3020. Thus, the product information is able to be easily viewed.

<<Method of Recognizing Position of Electronic Shelf Label 3000>>

For example, the shelf label recognition unit 2040 recognizes the coordinate of the electronic shelf label 3000 on the target image 10, as the position of the electronic shelf label 3000. The method of recognizing the coordinate of the electronic shelf label 3000 on the target image 10 is the same as the method of causing the product recognition unit 2020 to recognize the coordinate of the product group area.

<Details of Determination Unit 2060>

<<Example of Relation Information>>

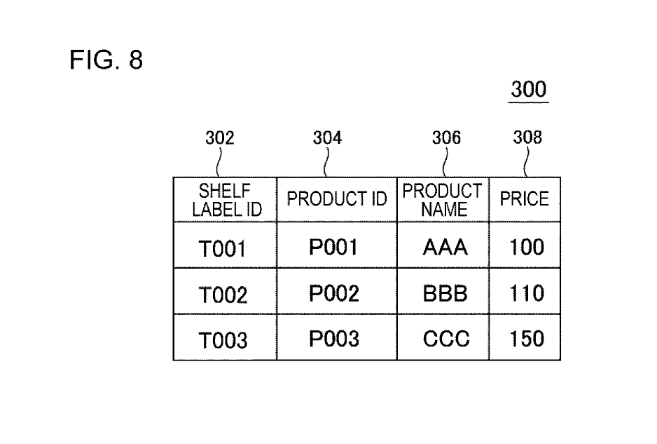

FIG. 8 is a diagram illustrating the relation information in a table format. The table of FIG. 8 is described as a relation information table 300. The relation information table 300 includes four columns of a shelf label ID 302, a product ID 304, a product name 306, and a price 308. The shelf label ID 302 is the shelf label ID of the electronic shelf label 3000. The product ID 304, the product name 306, and the price 308 are equivalent to the product ID 202, the product name 204, and the price 206 of the product information table 200.

For example, the relation information is stored in a relation information storage unit provided inside or outside the information processing apparatus 2000.

<<Method of Determining Closest Electronic Shelf Label 3000 and Product>>

For example, the determination unit 2060 determines the electronic shelf label 3000 closest to the product 40 for each product 40. Here, the “closet electronic shelf label 3000” is the electronic shelf label 3000 the distance from the product 40 of which is minimal. The determination unit 2060 determines the combination of the “product 40 and electronic shelf label 3000 closest to the product 40” as the “product 40 and electronic shelf label 3000 closet to each other”. For example, the determination unit 2060 calculates the distance between the product 40 and each electronic shelf label 3000. The determination unit 2060 determines the electronic shelf label 3000 the calculated value of which is minimal, as the electronic shelf label 3000 closest to the product 40.

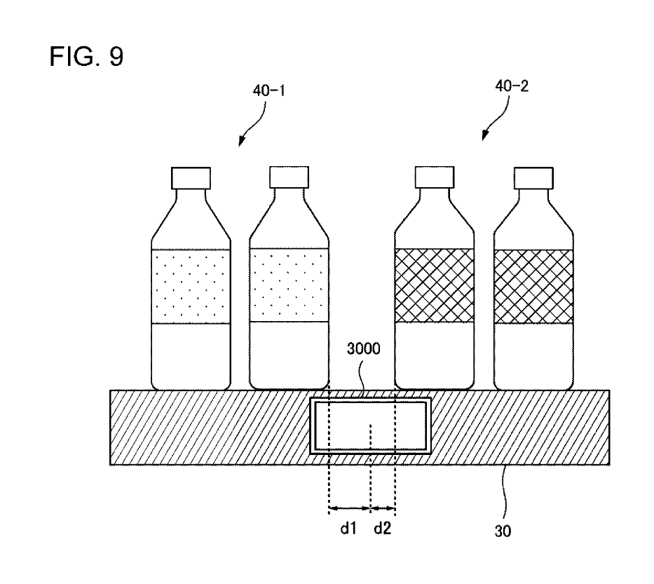

For example, the determination unit 2060 calculates the distance between the product 40 and the electronic shelf label 3000, as a length between the position of the product 40 and the position of the electronic shelf label 3000. Here, in a case where the product recognition unit 2020 recognizes the plurality of positions of the product as stated above, the determination unit 2060 may cause the position of the product 40 used for calculating the distance between the product 40 and the electronic shelf label 3000 to be different based on the positional relationship between the product 40 and the electronic shelf label 3000. FIG. 9 is a diagram illustrating the distance between the product 40 and the electronic shelf label 3000. In FIG. 9, the product 40-1 is located on the left side of the electronic shelf label 3000. Thus, the determination unit 2060 calculates a distance d1 between the product 40-1 and the electronic shelf label 3000, as a distance of a coordinate of the right end of the product group area of the product 40-1 and a coordinate of the center of the electronic shelf label 3000. On the other hand, the product 40-2 is located on the right side of the electronic shelf label 3000. Thus, the determination unit 2060 calculates a distance d2 between the product group area of the product 40-2 and the electronic shelf label 3000, as a distance between a coordinate of the left end of the product group area of the product 40-2 and a coordinate of the center of the electronic shelf label 3000.

In another example, the determination unit 2060 may determine “product 40 and electronic shelf label 3000 closest to each other” by determining the product 40 closest to the electronic shelf label 3000 for each electronic shelf label 3000. In this case, the determination unit 2060 determines the combination of the “electronic shelf label 3000 and the product 40 closest to the electronic shelf label 3000”, as “product 40 and electronic shelf label 3000 closest to each other”. Here, the method of calculating the electronic shelf label 3000 closest to the product 40 is the same as the method of calculating the product 40 closest to the electronic shelf label 3000.

Note that, in a case where a plurality of rows of the product shelving is pictured on the target image, the determination unit 2060 may take into consideration which product 40 and which electronic shelf label 3000 are included in the same row. Specifically, the determination unit 2060 limits the electronic shelf label 3000, which is handled as a determination target of whether or not the electronic shelf label is closest to the product 40, to the electronic shelf label 3000 included in the same row as this product 40.

Although it has been described in FIG. 4 that the product 40 associated with the electronic shelf label 3000 is placed on the shelf plate 30, an exhibition method of placing the product 40 associated with the electronic shelf label 3000 under the shelf plate 30 is also used. That is, a certain row of the product shelving becomes 1) an area including the shelf plate 30 and the product 40 placed on the shelf plate 30 or 2) an area including the shelf plate 30 and the product 40 placed under the shelf plate 30. Whether the determination unit 2060 recognizes 1) or 2) as the row is previously set. For example, information (information indicating whether the electronic shelf label 3000 is attached above or under the product 40) for determining whether the determination unit recognizes 1) or 2) as the row is stored in advance in the storage unit provided inside or outside the information processing apparatus 2000. The determination unit 2060 determines an area recognized as one row by referring to this information.

<<Details of Determination Process>>

After the combination of the product 40 and electronic shelf label 3000 closest to each other is determined from the target image, the determination unit 2060 determines whether or not the combination of the “product information and shelf label ID” thereof and the combination of the “product information and shelf label ID” indicated by the relation information match each other.

<<<Method 1>>>

For example, after the electronic shelf label 3000 closest to the product 40 is determined for each product 40, the determination unit 2060 determines whether or not the shelf label ID of the electronic shelf label 3000 matches the shelf label ID associated with the product 40 in the relation information. Here, as mentioned above, the product ID of each product pictured on the target image is determined by the product recognition unit 2020. Thus, the determination unit 2060 acquires the relation information in which the product information indicates the product ID of the product 40, and determines whether or not the shelf label ID indicated by the relation information matches the shelf label ID of the electronic shelf label 3000 closest to the product 40. In a case where it is determined as non-matching, the determination unit 2060 determines that the combination of the “product information and shelf label ID” corresponding to the combination of the product 40 and electronic shelf label 3000 closest to each other recognized from the target image does not match the combination of the “product information and the shelf label ID” indicated by the relation information. On the other hand, in a case where it is determined as matching, the determination unit 2060 determines “matching”.

<<<Method 2>>>

For example, after the product 40 closest to each electronic shelf label 3000 is determined, the determination unit 2060 determines whether or not the product information of the product 40 matches the product information associated with the shelf label ID of the electronic shelf label 3000 in the relation information. In a case where it is determined as non-matching, the determination unit 2060 determines that the combination of the “product information and shelf label ID” corresponding to the combination of the product 40 and electronic shelf label 3000 closest to each other recognized from the target image does not match the combination of the “product information and the shelf label ID” indicated by the relation information. On the other hand, in a case where it is determined as matching, the determination unit 2060 determines “matching”.

<<<Method 3>>>

For example, the determination unit 2060 determines whether or not the relation information indicating the combination of the “product information and the shelf label ID” is present in the relation information storage unit for the combination of the “product information and shelf label ID” corresponding to the combination of “product 40 and electronic shelf label 3000 closest to each other” recognized from the target image. In a case where the relation information indicating the combination matching the combination of the “product information and the shelf label ID” corresponding to the combination of certain “product 40 and electronic shelf label 3000 closest to each other” recognized from the target image is not present, the determination unit 2060 determines that the combination of the “product information and shelf label ID” corresponding to the combination of the product 40 and electronic shelf label 3000 closest to each other recognized from the target image does not match the combination of the “product information and the shelf label ID” indicated by the relation information. On the other hand, in a case where the relation information is present, the determination unit 2060 determines as “matching”.

<<<Method 4>>>

For example, for each combination of the “product information and shelf label ID” indicated by the relation information, the determination unit 2060 determines whether or not the combination of the “product 40 and electronic shelf label 3000” corresponding to the combination of the “product information and electronic shelf label ID” is included in the combinations of the “product 40 and electronic shelf label 3000 closest to each other” recognized from the target image. In a case where, for a certain combination of the “product information and shelf label ID”, the combination of the “product 40 and electronic shelf label 3000” corresponding to that “product information and shelf label ID” is not included in the combinations of the “product 40 and electronic shelf label 3000 closest to each other” recognized from the target image, the determination unit 2060 determines that the combinations of the “product information and shelf label ID” corresponding to the combination of the product 40 and electronic shelf label 3000 closest to each other recognized from the target image does not match the combination of “product information and shelf label ID” indicated by the relation information for the combination of the “product information and shelf label ID” indicated by the relation information. On the other hand, in a case where the combination thereof is included, the determination unit 2060 determines as “matching”.

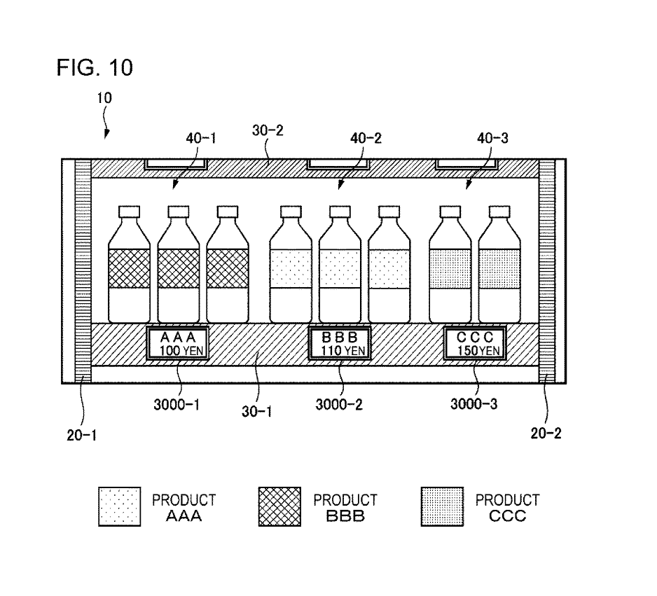

The determination process performed by the determination unit 2060 will be described in detail with reference to FIGS. 4 and 10. FIG. 10 is a diagram illustrating a case where the arrangement of Products AAA and BBB on the target image 10 of FIG. 4 is changed. In a specific example to be described below, it is assumed that the relation information table 300 illustrated in FIG. 8 is stored in the relation information storage unit. In the following example, the determination unit 2060 performs the process described in Method 1 stated above.

Here, suppose that the shelf label ID of the electronic shelf label 3000-1 is T001, the shelf label ID of the electronic shelf label 3000-2 is T002, and the shelf label ID of the electronic shelf label 3000-3 is T003. Thus, in the relation information table 300 illustrated in FIG. 8, Product AAA is associated with the electronic shelf label 3000-1, Product BBB is associated with the electronic shelf label 3000-2, and Product CCC is associated with the electronic shelf label 3000-3.

In the target image 10 of FIG. 4, the electronic shelf label 3000 closest to Product AAA is the electronic shelf label 3000-1. Accordingly, as for Product AAA, the determination unit 2060 determines that the shelf label ID of the electronic shelf label 3000 associated therewith in the relation information matches the shelf label ID of the electronic shelf label 3000 closest thereto on the target image. The determination unit 2060 performs the same determination on Product BBB and Product CCC.

On the other hand, the target image 10 of FIG. 10, the electronic shelf label 3000 closest to Product AAA is the electronic shelf label 3000-2. However, as mentioned above, the electronic shelf label 3000 associated with Product AAA in the relation information is the electronic shelf label 3000-1. Accordingly, as for Product AAA, the determination unit 2060 determines that the shelf label ID of the electronic shelf label 3000 associated therewith in the relation information does not match the shelf label ID of the electronic shelf label 3000 closest thereto on the target image. The determination result for Product BBB is similar to that for Product AAA.

Note that, in a case where the product information such as the product name is displayed on the electronic shelf label 3000 as illustrated in FIG. 4 or 10, a method of determining whether the relation information is correct or incorrect is considered to be “recognizing the product information displayed on the electronic shelf label 3000 through character string recognition, and determining whether or not the recognized product information matches the product information associated with the electronic shelf label 3000 in the relation information”. The information processing apparatus 2000 of Exemplary Embodiment 1 may perform the determination according to this method.

However, in general, in a case where characters indicating the product information are small or in a case where a lot of the electronic shelf labels 3000 are pictured on the target image, it is necessary to sufficiently increase the resolution of the camera that images the target image in order to accurately recognize the product information displayed on each electronic shelf label 3000. As a result, the size of the camera is increased or the price of the camera is increased.

In contrast, by making the recognition of the shelf label ID easier than the recognition of the product information, the resolution of the camera required to recognize the shelf label ID from the target image is allowed to be less than the resolution of the camera required to recognize the product information from the target image. Specifically, by displaying the shelf label ID with a large size by constituting the shelf label ID with a shorter character string than the product name or displaying only the shelf label ID on the electronic shelf label 3000 with a large size as illustrated in FIG. 7B, it is possible to suppress the resolution of the camera required to recognize the shelf label ID from the target image so as to be low. By doing so, it is possible to use more compact and lower-price camera comparing to a case where a way of recognizing the product information on the electronic shelf label 3000 from the target image is adopted.

<Timing when Information Processing Apparatus 2000 Performs Processes>

There are various timings when the information processing apparatus 2000 performs the series of processes. For example, the information processing apparatus 2000 periodically performs the processes. In this case, for example, a date and time or a cycle in which the process is performed is set for the information processing apparatus 2000 in advance. For example, the information processing apparatus 2000 may perform the process when the operation of the salesperson is received. The information processing apparatus 2000 may perform the process when the target image is generated or when the target image is acquired.

For example, suppose that the electronic shelf label 3000 transitions from the aforementioned first mode (the state in which the product information is displayed) to the second mode (the state in which the shelf label ID is displayed) at a cycle such as once every hour and transitions to the first mode again after several seconds. In this case, the target image on which the electronic shelf label 3000 displaying the shelf label ID is pictured is imaged at the aforementioned cycle. In this case, for example, the information processing apparatus 2000 performs the process at the aforementioned cycle. By doing this, it is periodically determined whether or not the relationship between the product and electronic shelf label 3000 pictured on the target image and the relationship between the product and electronic shelf label 3000 indicated by the relation information is correct.

### Exemplary Embodiment 2

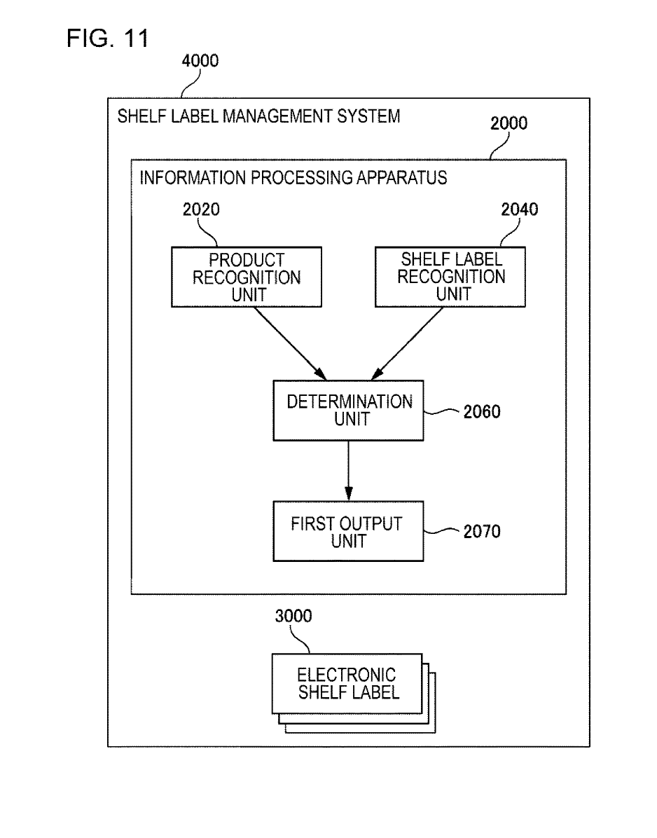

FIG. 11 is a block diagram illustrating an information processing apparatus 2000 according to Exemplary Embodiment 2. In FIG. 11, arrows represent information flows. In FIG. 11, each block represents not a configuration of a hardware unit but a configuration of a functional unit. Except for the following description, the information processing apparatus 2000 of Exemplary Embodiment 5 has the same configuration as that of the information processing apparatus 2000 of Exemplary Embodiment 1.

The information processing apparatus 2000 of Exemplary Embodiment 2 includes a first output unit 2070. The first output unit 2070 outputs the determination result performed by the determination unit 2060.

<Output Form>

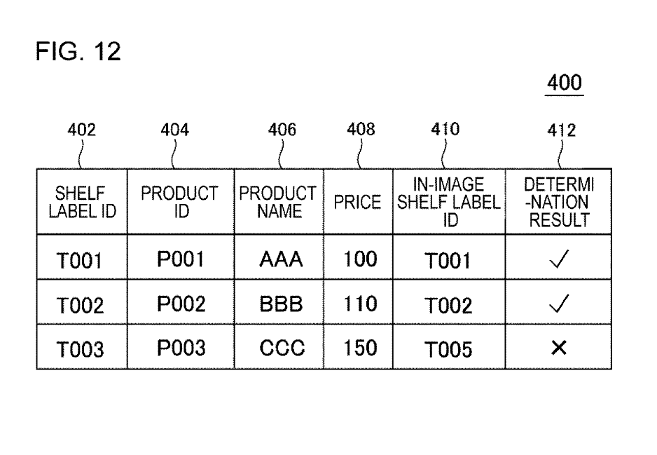

For example, the first output unit 2070 outputs the determination result in a table format. FIG. 12 is a diagram illustrating the determination result output by the first output unit 2070 in a table format. The table illustrated in FIG. 12 will be described as a determination result table 400. The determination result table 400 includes six columns of a shelf label ID 402, a product ID 404, a product name 406, a price 408, an in-image shelf label ID 410, and a determination result 412. The shelf label ID 402 to the price 408 are equivalent to the shelf label ID 302 to the price 308 of FIG. 9, respectively. The in-image shelf label ID 410 is a shelf label ID of the electronic shelf label 3000 closest to the product determined by the product ID 404 on the target image. Thus, in a case where the shelf label ID 402 and the in-image shelf label ID 410 match to each other, the determination result performed by the determination unit 2060 is “matching”, and in a case where the shelf label ID 402 and the in-image shelf label ID 410 do not match each other, the determination result performed by the determination unit 2060 is “non-matching”. The determination result 412 indicates the determination result performed by the determination unit 2060. A check mark represents “matching”, and an x mark represents “non-matching”.

Note that, in a case where the position of the product or the electronic shelf label 3000 within the store is managed in a database, the position thereof may be included in the determination result table 400. By doing this, the salesperson can easily recognize the position of the product or the electronic shelf label 3000 being the determination target within the store.

<Output Location>

There are various output locations to which the first output unit 2070 performs the aforementioned output. For example, the first output unit 2070 performs the output on a display screen connected to the information processing apparatus 2000. As a result, the determination result performed by the determination unit 2060 is displayed on the display screen. For example, the first output unit 2070 performs the output on a portable terminal used by the salesperson. As a result, the determination result performed by the determination unit 2060 is displayed on the display screen of the portable terminal. In this case, the portable terminal is connected to the information processing apparatus 2000 through, for example, a network line. The first output unit 2070 transmits the aforementioned display to the portable terminal through this network line.

Note that, the method of the output performed by the first output unit 2070 is not limited to the screen output. For example, the first output unit 2070 may output the aforementioned determination result table 400 as a file. The first output unit 2070 stores this file in the storage unit included in the information processing apparatus 2000, or transmits this file to the portable terminal of the salesperson.

<Flow of Processes>

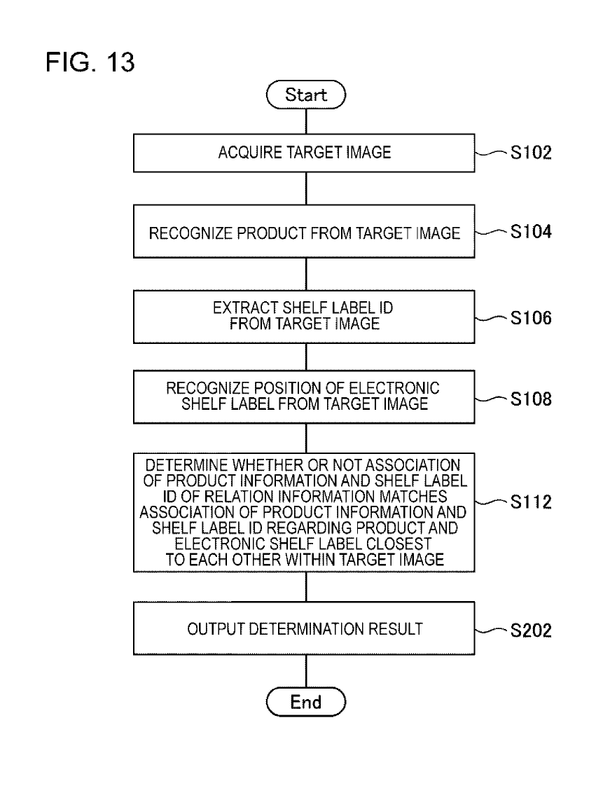

FIG. 13 is a flowchart illustrating a flow of processes performed by the information processing apparatus 2000 of Exemplary Embodiment 2. Here, in the respective steps of FIG. 13 that are assigned the same reference numerals as those of FIG. 2, the same processes are performed as those assigned the reference numerals of FIG. 2. Thus, the description of those processes will not be repeated.

After step S112 is performed, the first output unit 2070 outputs the determination result performed by the determination unit 2060 (S202).

According to the present exemplary embodiment, the determination result performed by the determination unit 2060 is output. Thus, the salesperson can easily recognize the non-matching between the association of the product and electronic shelf label 3000 recognized from the target image and the association of the product and the relation information table 300 of the relation information.

### Exemplary Embodiment 3

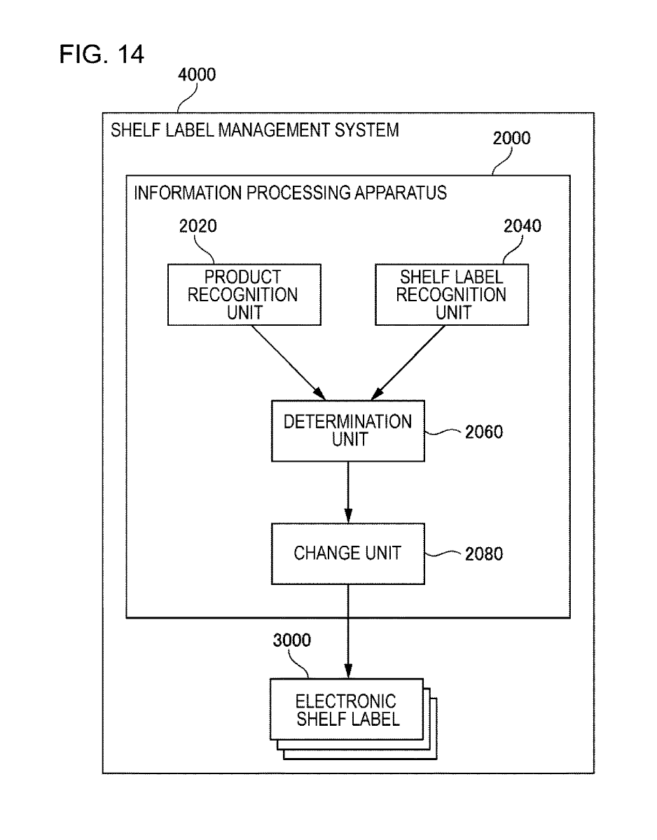

FIG. 14 is a block diagram illustrating an information processing apparatus 2000 according to Exemplary Embodiment 3 and a usage environment thereof. In FIG. 14, arrows represent information flows. In FIG. 14, each block represents not a configuration of a hardware unit but a configuration of a functional unit. Except for the following description, the information processing apparatus 2000 of Exemplary Embodiment 3 has the same configuration as that of the information processing apparatus 2000 of Exemplary Embodiment 1 or 2.

The information processing apparatus 2000 of Exemplary Embodiment 2 includes a change unit 2080. The change unit 2080 changes the association indicated by the relation information. Specifically, in a case where it is determined that “the shelf label ID associated with the product information of the recognized product in the relation information does not match the shelf label ID of the electronic shelf label closest to the recognized product”, the change unit 2080 changes the shelf label ID associated with the product information in the relation information to the shelf label ID of the electronic shelf label 3000 closest to the product 40 recognized from the target image.

For example, in the case of the example described with reference to FIG. 10, the change unit 2080 changes the shelf label ID associated with the product information of Product AAA in the relation information to the shelf label ID of the electronic shelf label 3000-2. Similarly, the change unit 2080 changes the shelf label ID associated with the product information of Product BBB in the relation information to the shelf label ID of the electronic shelf label 3000-1.

<Flow of Processes>

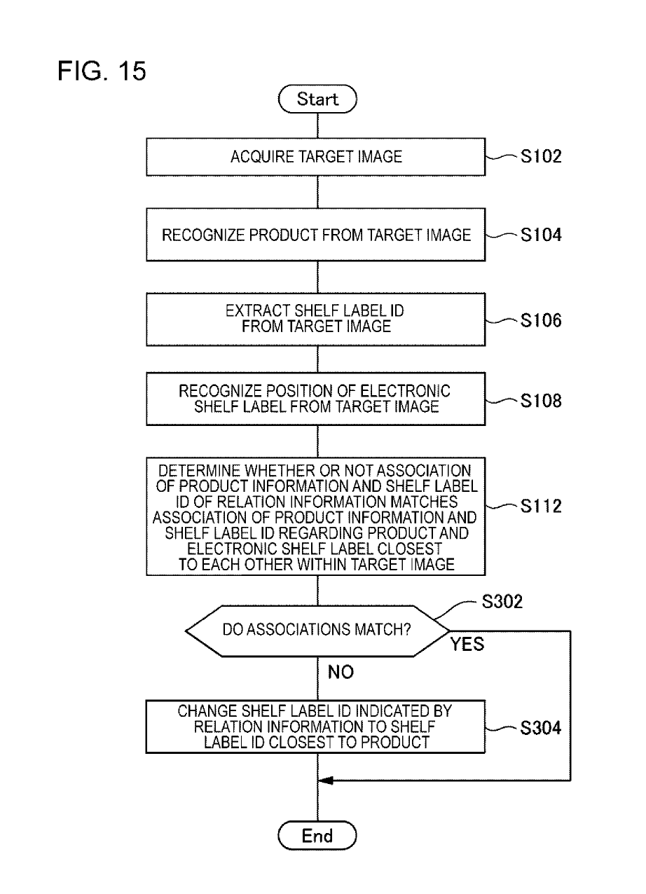

FIG. 15 is a flowchart illustrating a flow of processes performed by the information processing apparatus 2000 of Exemplary Embodiment 3. Here, in the respective steps of FIG. 15 that are assigned the same reference numerals as those of FIG. 2, the same processes are performed as those assigned the reference numerals of FIG. 2. Thus, the description of these processes will not be repeated.

After step S112 is performed, the process of FIG. 15 is branched at step S302. Specifically, in a case where it is determined as “matching” in step S112 (S302: YES), the process of FIG. 15 is ended. On the other hand, in a case where it is determined as “non-matching” in step S112 (S302: NO), the process of FIG. 15 proceeds to step S304. In step S304, the change unit 2080 changes the shelf label ID indicated by the relation information of the target determined as “non-matching” in step S112 to the shelf label ID of the electronic shelf label 3000 closest to the product 40 of the product information indicated by the relation information (S304).

According to the information processing apparatus 2000 of the present exemplary embodiment, the shelf label ID associated with the product information of each product in the relation information is changed to the shelf label ID of the electronic shelf label 3000 closest to this product. Thus, the relation information is automatically updated depending on a situation pictured on the target image. Accordingly, since the salesperson does not need to manually update the relation information when the replacement of the product is performed, it is easy to manage the relation information, and thus, the workload of the salesperson is reduced.

### Exemplary Embodiment 4

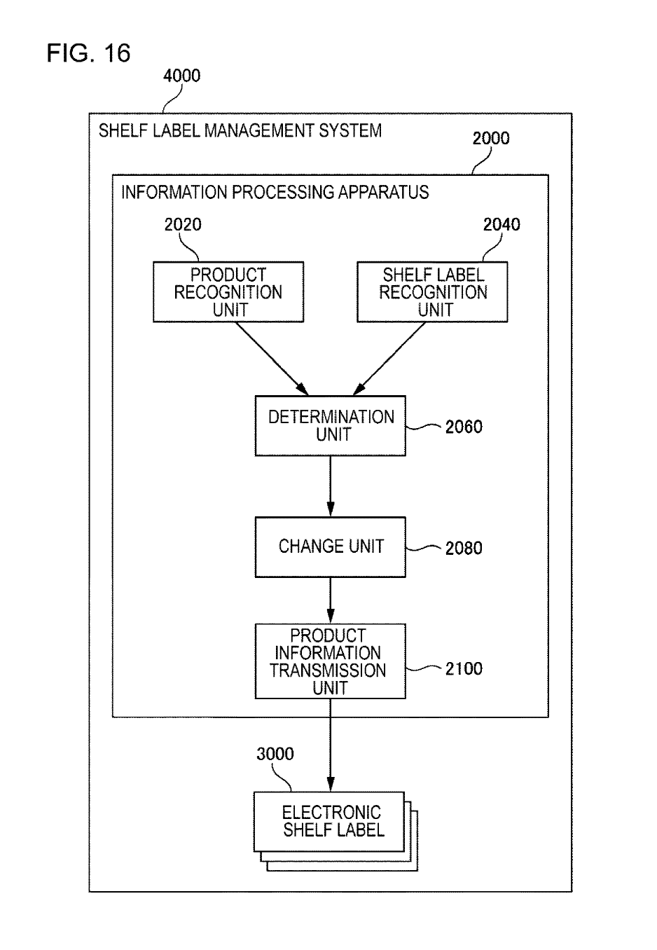

FIG. 16 is a block diagram illustrating an information processing apparatus 2000 of Exemplary Embodiment 4 and a usage environment thereof. In FIG. 16, arrows represent information flows. In FIG. 16, each block represents not a configuration of a hardware unit but a configuration of a functional unit. Except for the following description, the information processing apparatus 2000 of Exemplary Embodiment 4 has the same configuration as that of the information processing apparatus 2000 of Exemplary Embodiment 3.

The information processing apparatus 2000 of Exemplary Embodiment 4 includes a product information transmission unit 2100. The product information transmission unit 2100 transmits the product information to the electronic shelf label 3000 determined by the shelf label ID indicated by the relation information the association of which is changed. Here, the product information transmitted from the product information transmission unit 2100 to the electronic shelf label 3000 is the product information associated with the electronic shelf label 3000 in the relation information the association of which is changed by the change unit 2080.

For example, the product information transmission unit 2100 transmits the product information to the electronic shelf label 3000 by using infrared communication. Here, the method of transmitting the product information by the product information transmission unit 2100 is not limited to the method using the infrared communication. Various known techniques are used as the technique for transmitting information to the electronic shelf label 3000, and the product information transmission unit 2100 may transmit the information to the electronic shelf label 3000 by using these known techniques.

As stated above, the display unit 3020 displays the received product information. For example, the display unit 3020 displays the product name and the price indicated by the product information. Note that, the information displayed on the display unit 3020 may be a part or whole of the received product information. The product information transmitted from the product information transmission unit 2100 to the electronic shelf label 3000 may be a part or whole of the product information associated with the electronic shelf label 3000. For example, the product information transmission unit 2100 transmits only the price and the product name of the information included in the product information to the electronic shelf label 3000.

<Flow of Processes>

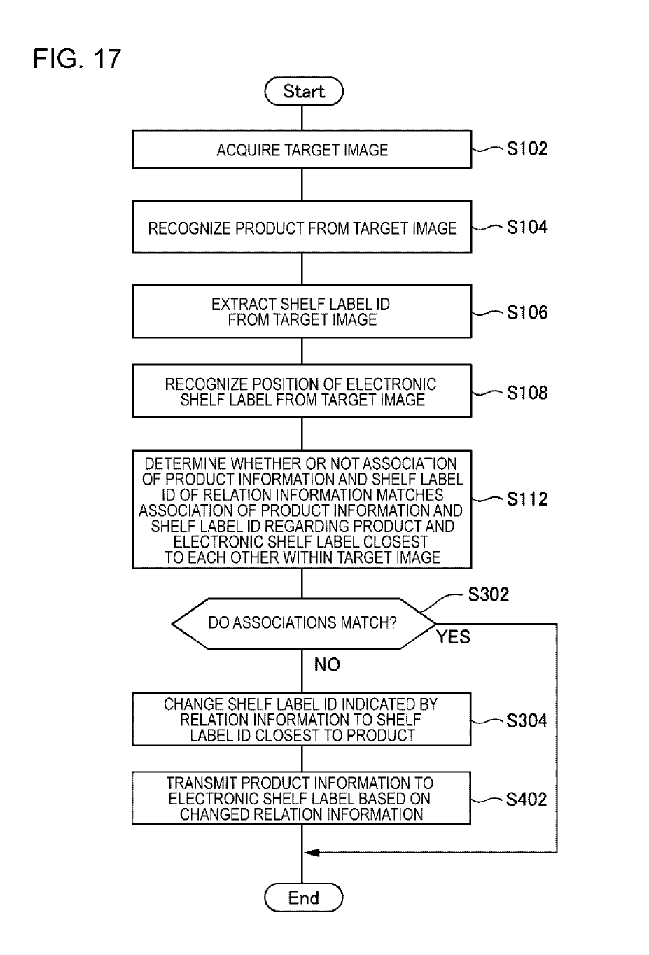

FIG. 17 is a flowchart illustrating a flow of processes performed by the information processing apparatus 2000 of Exemplary Embodiment 4. Here, in the respective steps of FIG. 17 that are assigned the same reference numerals as those of FIG. 15, the same processes are performed as those assigned the reference numerals of FIG. 15. Thus, the description of these processes will not be repeated.

After step S304 is performed, the product information transmission unit 2100 transmits the product information associated with the electronic shelf label 3000 to the electronic shelf label 3000 determined by the shelf label ID indicated by the relation information the association of which is changed (S402).

<Timing when Product Information Transmission Unit 2100 Operates>

There are various timings when the product information transmission unit 2100 operates. For example, the product information transmission unit 2100 transmits the product information when the relation information is changed by the change unit 2080 as illustrated in FIG. 17. However, a timing when the product information transmission unit 2100 operates is not limited to the timing illustrated in FIG. 17. For example, the product information transmission unit 2100 operates at a predetermined cycle. In this case, for example, the product information transmission unit 2100 transmits the product information for all the relation information that is changed from the previous operation to the current operation. In another example, the product information transmission unit 2100 may operate when the operation of the salesperson is received.

According to the present exemplary embodiment, the relation information the association of which is changed by the change unit 2080 is used to transmit the product information indicated by the relation information to the electronic shelf label 3000 identified by the shelf label ID indicated by the relation information. Accordingly, for example, if the product is replaced, the change of the relation information and the transmission of the product information to the electronic shelf label 3000 (the change of the display of the electronic shelf label 3000) based on the changed relation information are automatically performed using the target image acquired by imaging the replaced product and an area in the vicinity of this product. Thus, the workload such as the replaced operation of the product is reduced.

<Handling in Case where Plurality of Different Products 40 is Associated with Electronic Shelf Label 3000>

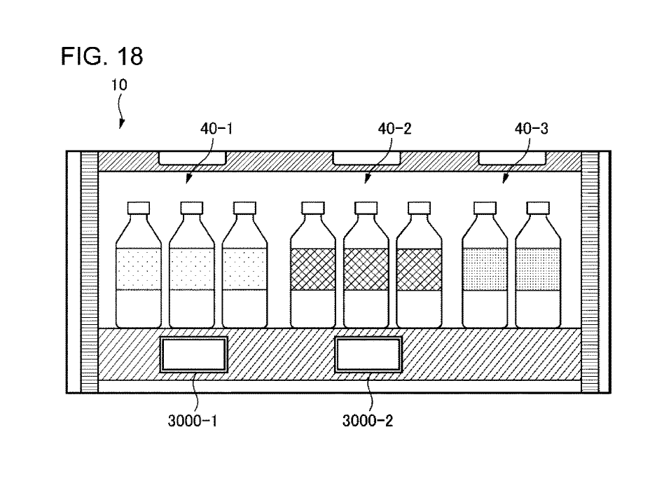

It is considered that the same electronic shelf label 3000 is closest from each of a plurality of products 40. FIG. 18 is a diagram illustrating a situation in which the same electronic shelf label 3000 is closest from each of the plurality of different products 40. In FIG. 18, both the electronic shelf label 3000 closest to the product 40-2 and the electronic shelf label 3000 closest to the product 40-3 are the electronic shelf label 3000-2.

For example, in such a case, there are a plurality of relation information that associate the product information of the plurality of different products 40 with the shelf label ID of the closest electronic shelf label 3000. In FIG. 18, there are both 1) the relation information associating the product information of the product of the product 40-2 with the electronic shelf label 3000-2 and 2) the relation information associating the product information of the product of the product 40-3 with the electronic shelf label 3000-2.

In this case, for example, the product information transmission unit 2100 transmits the plurality of product information associated with the electronic shelf label 3000 to one electronic shelf label 3000. In FIG. 18, the product information transmission unit 2100 transmits both the product information of the product of the product 40-2 and the product information of the product of the product 40-3 to the electronic shelf label 3000-2. For example, as the display performed by the electronic shelf label 3000 that receives the plurality of product information as stated above, there are two examples to be described below.

<<Plurality of Product Information is Simultaneously Displayed>>

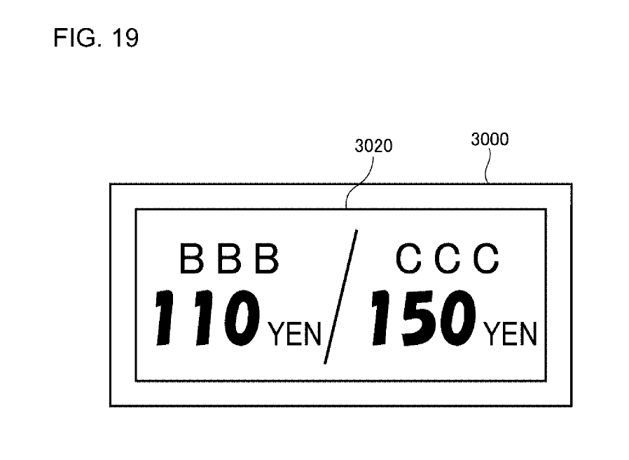

As a first example, the electronic shelf label 3000 simultaneously displays the plurality of received product information. FIG. 19 is a diagram illustrating a case where the electronic shelf label 3000 simultaneously displays two pieces of product information. The electronic shelf label 3000 displays the product information of the product 40 placed on the left side on the right side of the display unit 3020, and the product information of the product 40 placed on the right side on the right side of the display unit 3020.

<<Plurality of Product Information are Displayed in Time-Division Manner>>

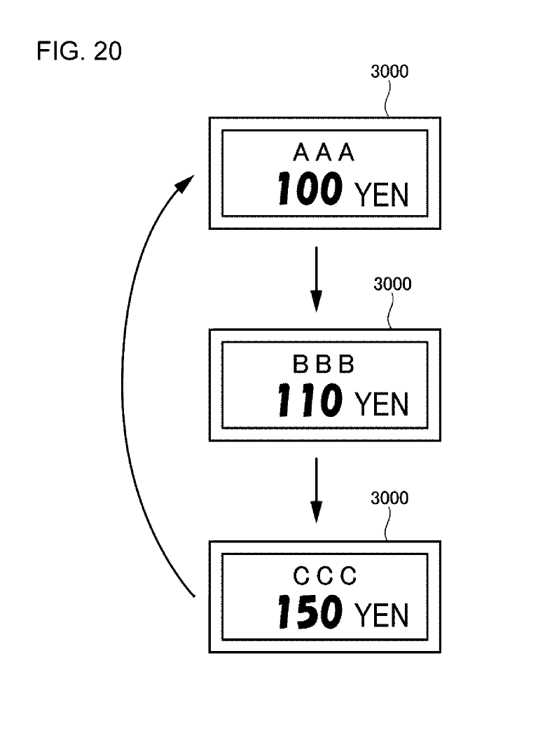

As a second example, the electronic shelf label 3000 displays the plurality of received product information in a time-division manner. FIG. 20 is a diagram illustrating a case where the electronic shelf label 3000 displays three pieces of product information in a time-division manner. The electronic shelf label 3000 may sequentially switch the display of the display unit 3020 in the order of 1) the product information of Product AAA, 2) the product information of Product BBB, 3) the product information of Product CCC, 4) the product information of Product AAA, . . . .

As the situation in which the plurality of different product information is associated with the same electronic shelf label 3000 as stated above, there is a situation in which there are not enough electronic shelf labels 3000. For example, the situation of FIG. 18 is a situation in which the electronic shelf label 3000 should be placed under the product 40-3. The plurality of product information is displayed on the electronic shelf label 3000 in a simultaneous or time-division manner as stated above, and thus, the product information of all the products are displayed on the electronic shelf label 3000 in a situation in which there are not enough electronic shelf labels 3000 is insufficient. Thus, a customer can recognize the product information of each product.

Note that, the information processing apparatus 2000 may have a function of performing the notification to the salesperson in a case where the plurality of pieces of product information are associated with the electronic shelf label 3000. The salesperson receives this notification, and performs an operation of adding the electronic shelf label 3000. In this case, the display of the plurality of product information using the electronic shelf label 3000 is performed as alternative measures until the salesperson performs the operation of adding the electronic shelf label 3000.

Here, in a case where the electronic shelf label 3000 is configured to “display the recently received product information”, it is considered that only the recently transmitted product information is displayed on the electronic shelf label 3000 even though the plurality of pieces of product information are transmitted to one electronic shelf label 3000. Thus, for example, in a case where the plurality of pieces of product information are to be displayed on the electronic shelf label 3000, the product information transmission unit 2100 transmits a flag indicating that the plurality of pieces of product information are to be displayed on the electronic shelf label together with the product information, to the electronic shelf label 3000. The electronic shelf label 3000 is configured to display all the plurality of pieces of product information received together with the flag, in a simultaneous or time-division manner.

### Exemplary Embodiment 5

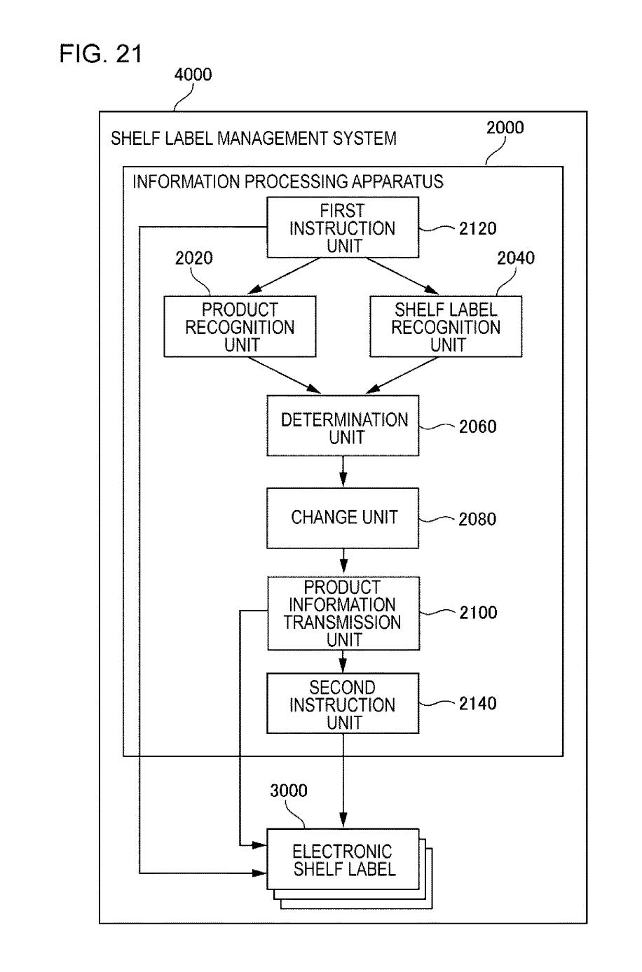

FIG. 21 is a block diagram illustrating an information processing apparatus 2000 of Exemplary Embodiment 5 and a usage environment thereof. In FIG. 21, arrows represent information flows. In FIG. 21, each block represents not a configuration of a hardware unit but a configuration of a functional unit. Except for the following description, the information processing apparatus 2000 of Exemplary Embodiment 5 has the same configuration as that of the information processing apparatus 2000 of Exemplary Embodiment 4.

In Exemplary Embodiment 5, the electronic shelf label 3000 may be in two states of the aforementioned first mode and second mode. The information processing apparatus 2000 of Exemplary Embodiment 3 transmits an instruction for switching between the two states to the electronic shelf label 3000. To do so, the information processing apparatus 2000 includes a first instruction unit 2120, and a second instruction unit 2140.

The first instruction unit 2120 transmits an instruction to switch from the first mode to the second mode (hereinafter, referred to as a first instruction) to the electronic shelf label 3000. The electronic shelf label 3000 that receives the first instruction transitions from the first mode to the second mode. The second instruction unit 2140 transmits an instruction to switch from the second mode to the first mode (hereinafter, referred to as a second instruction) to the electronic shelf label 3000. The electronic shelf label 3000 that receives the second instruction transitions from the second mode to the first mode.

Here, when the instruction is transmitted, the first instruction unit 2120 and the second instruction unit 2140 may transmits the instruction to all the electronic shelf labels 3000, or may transmit the instruction to only the determined electronic shelf label 3000. For example, in a case where the determination of the relation information should be performed for all the electronic shelf labels 3000 all at once or in a case where it is not able to determine for which electronic shelf label 3000 the determination of the relation information should be performed, the first instruction unit 2120 and the second instruction unit 2140 transmit the instruction to all the electronic shelf labels 3000 all at once. On the other hand, in a case where the electronic shelf label 3000 for which the determination of the relation information should be performed, the first instruction unit 2120 and the second instruction unit 2140 may transmit the instruction to only the determined electronic shelf label 3000. For example, as the situation in which the determined electronic shelf label 3000 is used as the target, there is a case where new products are exhibited and the electronic shelf label 3000 is accordingly added to under the products.

<Flow of Processes>

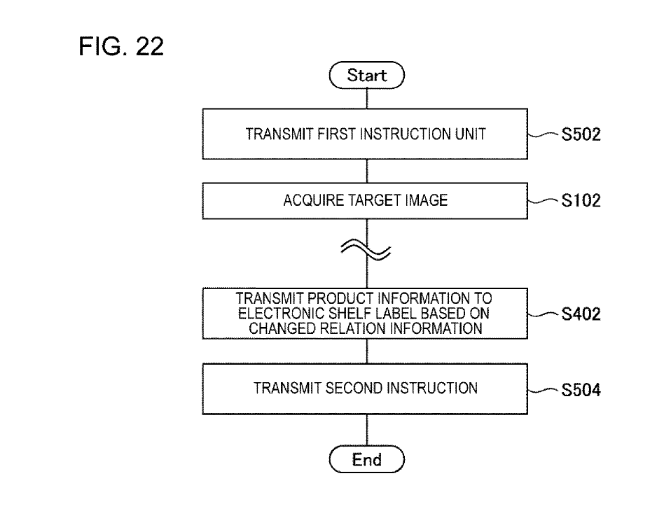

The information processing apparatus 2000 of Exemplary Embodiment 5 uses the target image on which the electronic shelf label 3000 in the second mode is imaged. Thus, for example, the information processing apparatus 2000 of Exemplary Embodiment 5 performs processes according a flow indicated by the flowchart of FIG. 22. Here, the processes performed in steps S102 to S402 of FIG. 22 are the same as the processes performed in steps S102 to S402 of FIG. 17. Thus, for brevity, the respective steps that are performed after step S102 and before step S402 will not be illustrated in FIG. 22.

Initially, the first instruction unit 2120 transmits the first instruction to the electronic shelf label 3000 (S502). As a result, the electronic shelf label 3000 displays the shelf label ID. Thereafter, the processes of step S102 to step S402 are performed. After the product information transmission unit 2100 transmits the product information, the second instruction unit 2140 transmits the second instruction to the electronic shelf label 3000 (S504). As a result, the product information transmitted by the product information transmission unit 2100 is displayed on the electronic shelf label 3000.

Here, a timing when the first instruction unit 2120 or the second instruction unit 2140 operates is not limited to the timing illustrated in FIG. 22. For example, in a case where the product information transmission unit 2100 transmits the product information to the plurality of electronic shelf labels 3000, the second instruction unit 2140 may operate after the product information transmission unit 2100 finishes the transmission of the product information to all the electronic shelf labels 3000.

### Exemplary Embodiment 6

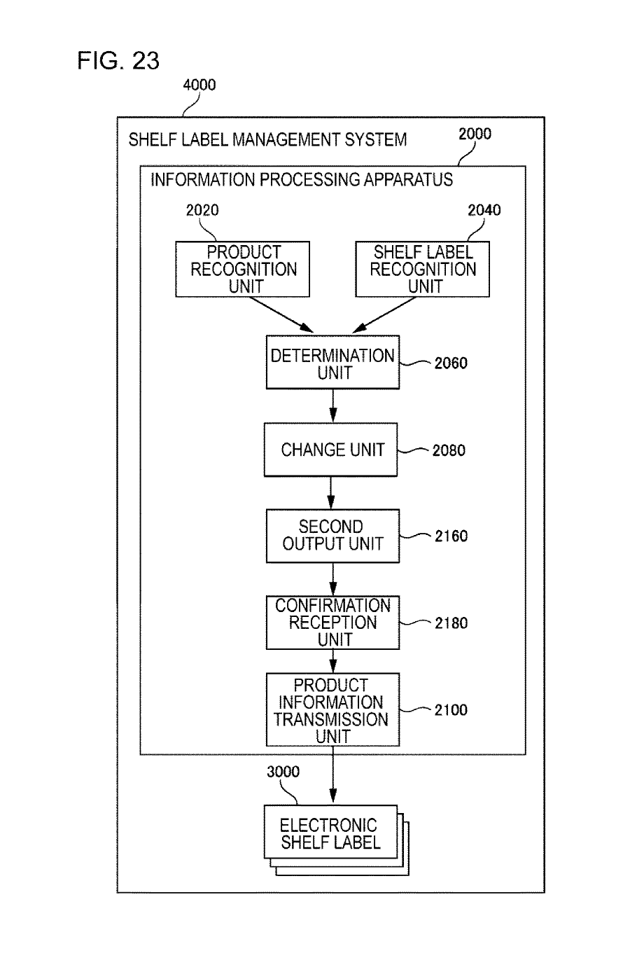

FIG. 23 is a block diagram illustrating an information processing apparatus 2000 of Exemplary Embodiment 6 and a usage environment thereof. In FIG. 23, arrows represent information flows. In FIG. 23, each block represents not a configuration of a hardware unit but a configuration of a functional unit. Except for the following description, the information processing apparatus 2000 of Exemplary Embodiment 6 has the same configuration as that of the information processing apparatus 2000 of Exemplary Embodiment 4 or 5.

The information processing apparatus 2000 of Exemplary Embodiment 6 receives a confirmation of whether or not the relation information changed by the change unit 2080 is correct. The information processing apparatus 2000 transmits the product information to the electronic shelf label 3000 by using the relation information the association of which is confirmed as being correct.

To do so, the information processing apparatus 2000 of Exemplary Embodiment 6 includes a second output unit 2160, and a confirmation reception unit 2180. The second output unit 2160 outputs the relation information changed by the change unit 2080. The confirmation reception unit 2180 receives a confirmation indicating that the association indicated by the relation information is correct. The product information transmission unit 2100 of Exemplary Embodiment 6 transmits the product information by using the relation information the association of which is confirmed as being correct. Here, the electronic shelf label 3000 of a transmission destination is the electronic shelf label 3000 having the shelf label ID indicated by the relation information the association of which is confirmed as being correct. The transmitted product information is the product information indicated by the relation information.

<Output Form>

For example, the second output unit 2160 outputs the relation information changed by the change unit 2080 in the same form of the relation information table 300 illustrated in FIG. 8. The confirmation reception unit 2180 receives an input of whether or not the relation information represented in each row is correct for each row of the relation information table 300. Note that, the second output unit 2160 may output all the relation information as well as the changed relation information.

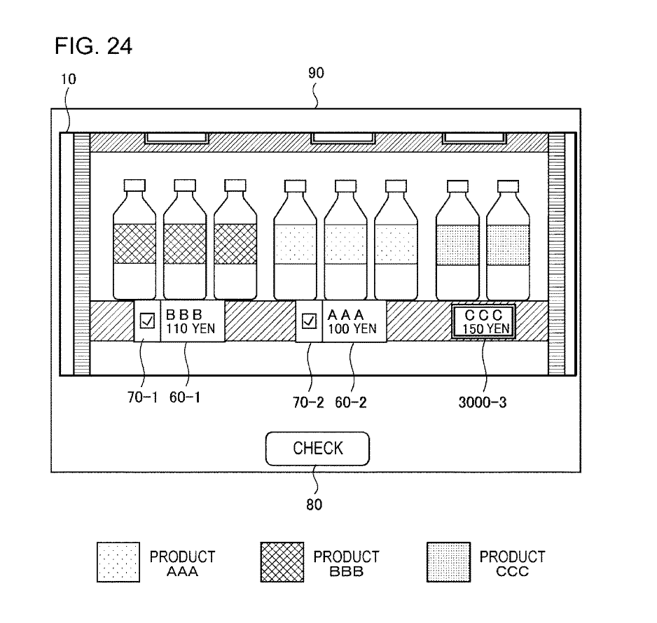

The second output unit 2160 may output the relation information by using the target image. Specifically, the second output unit 2160 displays the product information associated with the electronic shelf label 3000 near each electronic shelf label 3000 on the target image. FIG. 24 is a diagram illustrating a case where the changed relation information is displayed on the target image 10. A screen 90 is a screen output by the second output unit 2160. The screen 90 includes the target image 10 and a check button 80. Note that, the screen 90 is displayed on the display screen of the terminal operated by the salesperson.

The target image 10 of FIG. 24 illustrates the same situation as the situation of the specific example described with reference to FIG. 10 in Exemplary Embodiment 1. Specifically, this diagram illustrates a situation in which the products arranged in the order of Products AAA, BBB, and CCC from the left of FIG. 4 are rearranged in the order of the products BBB, AAA, and CCC. Thus, the change unit 2080 changes the shelf label ID associated with the product information of Product BBB in the relation information from the shelf label ID of the electronic shelf label 3000-2 to the shelf label ID of the electronic shelf label 3000-1. Similarly, the change unit 2080 changes the shelf label ID associated with the product information of Product AAA in the relation information from the shelf label ID of the electronic shelf label 3000-1 to the shelf label ID of the electronic shelf label 3000-2. On the other hand, since the position of Product CCC is not changed, the relation information indicating Product CCC is not changed.

Thus, on the target image 10 of FIG. 24, the product information 60-1, which is newly associated with the shelf label ID of the electronic shelf label 3000-1, is displayed in a position equivalent to the position in which the electronic shelf label 3000-1 is displayed on the target image 10 of FIG. 10. The product information 60-1 is the product information of Product BBB. Similarly, on the target image 10, product information 60-2, which is newly associated with the shelf label ID of the electronic shelf label 3000-2, is displayed in a position equivalent to the position in which the electronic shelf label 3000-2 is displayed on the target image 10 of FIG. 10. The product information 60-2 is the product information of Product AAA. Here, the positions of the electronic shelf label 3000-2 and the electronic shelf label 3000-3 on the target image 10 are recognized by the shelf label recognition unit 2040. Thus, the second output unit 2160 can determine the positions in which the product information 60-1 and the product information 60-2 are to be displayed by using these positions.

By displaying the product information 60 so as to be superimposed on the electronic shelf label 3000 as stated above, the salesperson who sees the screen 90 can virtually see the result of the product information 60 transmitted to the electronic shelf label 3000. Thus, the salesperson can easily and intuitively confirms whether or not the product information 60 is correct by comparing the product information 60 with the product 40.

In FIG. 24, a check box 70 is displayed on the left of the product information 60. The salesperson adds the check mark in the check box 70 next to the product information 60 if the content of the product information 60 is correct. In FIG. 24, the check mark is added in each check box 70. This check mark represents that it is determined that “the product information 60 displayed next to the check box 70 is correct”. The salesperson finally finishes the input by pressing the check button 80.

In a case where the check button 80 is pressed, the confirmation reception unit 2180 acquires the state of the check box 70. As for the product information 60 in which the check mark is added in the check box 70, the confirmation reception unit 2180 determines that the input indicating “the association is correct” is performed. By displaying the check box 70, which is an input interface to the confirmation reception unit 2180, next to the product information 60 as stated above, the salesperson can easily and intuitively input the confirmation result of the relation information.

<Output Location>

The output location of the output performed by the second output unit 2160 is the same as the output location of the output performed by the second output unit 2160 described in Exemplary Embodiment 2.

<Input Method to Confirmation Reception Unit 2180>

The input method to the confirmation reception unit 2180 is, for example, a method using the aforementioned check box. In another example, in a case where the second output unit 2160 outputs the relation information as the file, the confirmation reception unit 2180 may receive the file to which the information of whether or not each pieces of relation information is correct is added to this file, as the input.

For example, in a case where the second output unit 2160 outputs the relation information on the display screen connected to the information processing apparatus 2000, the input to the confirmation reception unit 2180 is performed through an input device such as a keyboard connected to the information processing apparatus 2000. Meanwhile, in a case where the second output unit 2160 transmits the display to the portable terminal of the salesperson, the input to the confirmation reception unit 2180 is performed through the input device of this portable terminal. The information input to the portable terminal is transmitted to the information processing apparatus 2000 through the aforementioned network line.

<Flow of Processes>

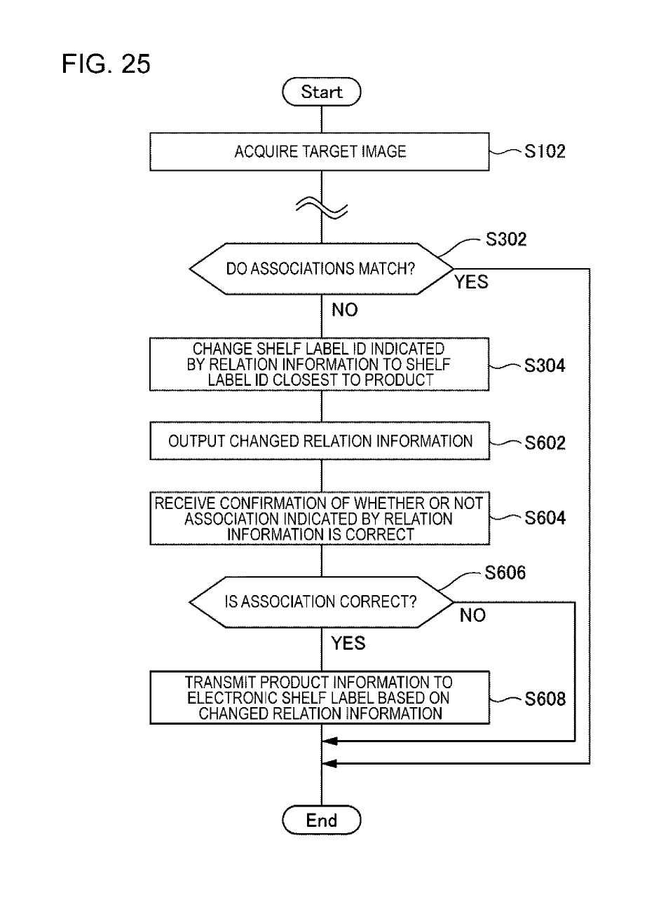

FIG. 25 is a flowchart illustrating a flow of processes performed by the information processing apparatus 2000 of Exemplary Embodiment 6. Here, the processes in steps S102 to S304 of FIG. 25 are the same as the processes performed in steps S102 to S304 of FIG. 17. Thus, for brevity, the respective steps that are performed after step S102 and before step S302 will not be illustrated in FIG. 25.

After step S304 is performed, the second output unit 2160 outputs the relation information (S602). The confirmation reception unit 2180 receives the confirmation of whether or not the association indicated by the changed relation information is correct (S604). In a case where the input indicating that the association indicated by the relation information is correct is performed (S606: YES), the process of FIG. 25 proceeds to step S608. In step S608, the product information transmission unit 2100 transmits the product information to the electronic shelf label 3000. On the other hand, in a case where the input indicating that the association using the relation information is correct is not performed (S606: NO), the process of FIG. 25 is ended.

According to the present exemplary embodiment, among the relation information changed by the change unit 2080, the product information indicated by the relation information the association of which is confirmed as being correct is transmitted to the product information transmission unit 2100. Thus, even though the change performed by the change unit 2080 is incorrect, it is possible to prevent the incorrect product information from being displayed on the electronic shelf label 3000.

### Exemplary Embodiment 7

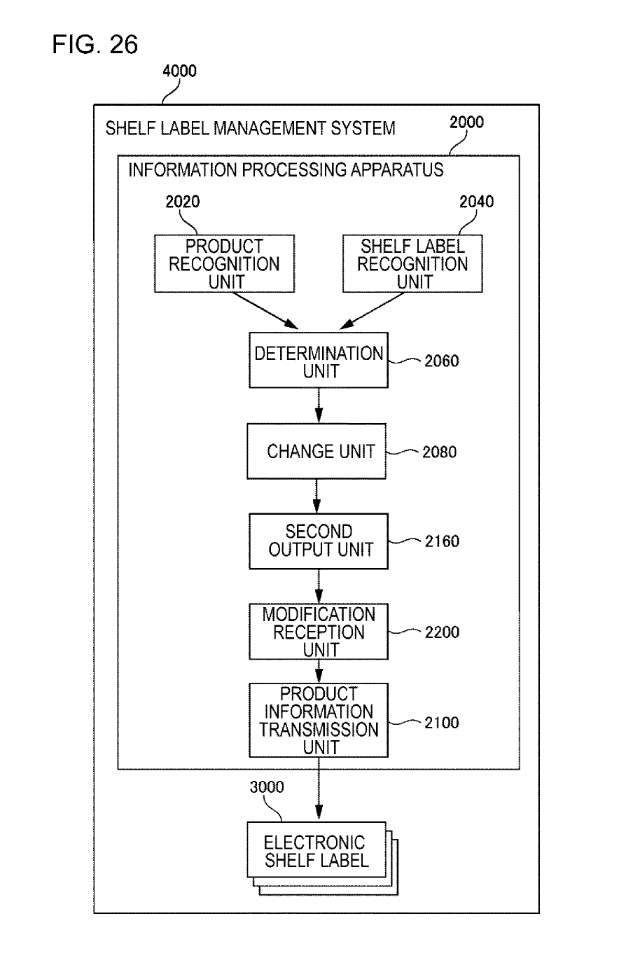

FIG. 26 is a block diagram illustrating an information processing apparatus 2000 of Exemplary Embodiment 7 and a usage environment thereof. In FIG. 26, arrows represent information flows. In FIG. 26, each block represents not a configuration of a hardware unit but a configuration of a functional unit. Except for the following description, the information processing apparatus 2000 of Exemplary Embodiment 7 has the same configuration as that of the information processing apparatus 2000 of Exemplary Embodiment 4 or 5.

The information processing apparatus 2000 of Exemplary Embodiment 7 outputs the relation information changed by the change unit 2080, and receives a modification of the relation information. The information processing apparatus 2000 transmits the product information based on the modified relation information.

To do so, the information processing apparatus 2000 of Exemplary Embodiment 7 includes a second output unit 2160, and a modification reception unit 2200. The second output unit 2160 is the same functional configuration unit as the second output unit 2160 of Exemplary Embodiment 6. The modification reception unit 2200 receives the modification of the relation information displayed by the second output unit 2160. The product information transmission unit 2100 transmits the product information by using the modified relation information. Here, the electronic shelf label 3000 of the transmission destination is the electronic shelf label 3000 having the shelf label ID indicated by the modified relation information. The transmitted product information is the product information indicated by the relation information.

<Input Method to Modification Reception Unit 2200>

For example, in the information processing apparatus 2000 of Exemplary Embodiment 7, the second output unit 2160 displays the image on which the product information 60 is displayed on the target image 10 on the display screen similarly to the second output unit 2160 of Exemplary Embodiment 6. Here, in Exemplary Embodiment 7, the character string displayed on each pieces of product information 60 of FIG. 24 may be changed by a key input. The modification reception unit 2200 receives the change of the content of the product information 60, as the modification of the relation information.

If the confirmation and modification of the relation information is finished, the salesperson presses the check button 80. Thereafter, the modification reception unit 2200 acquires the content of the modification of the product information 60 input on the screen 90. The modification reception unit 2200 modifies the relation information based on the acquired content.

Here, the modification method of the relation information is not limited to the aforementioned method. For example, in a case where the second output unit 2160 displays the relation information on the display screen in a table format, the modification reception unit 2200 receives the modification of this table. In another example, in a case where the second output unit 2160 outputs and displays the relation information as the file, the modification reception unit 2200 may receives the input of the file of which the content information is modified.

<Flow of Processes>

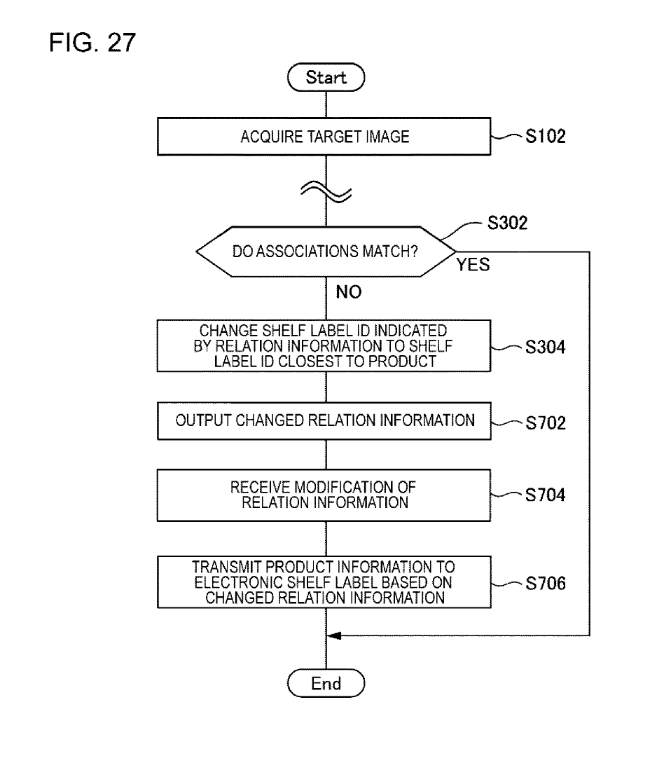

FIG. 27 is a flowchart illustrating a flow of processes performed by the information processing apparatus 2000 of Exemplary Embodiment 7. Here, the processes in steps S102 to S304 of FIG. 27 are the same as the processes performed in steps S102 to S304 of FIG. 17. Thus, for brevity, the respective steps that are performed after step S102 and before step S302 will not be illustrated in FIG. 27.

After step S304 is performed, the second output unit 2160 outputs the relation information changed by the change unit 2080 (S702). The modification reception unit 2200 receives the modification of the relation information (S704). The product information transmission unit 2100 transmits the product information (step S706). Here, in a case where the relation information is not modified in step S704, the product information indicated by the relation information changed by the change unit 2080 is transmitted without being modified.

According to the present exemplary embodiment, it is possible to modify the relation information the association of which is incorrect, among the relation information changed by the change unit 2080. Thus, even in a case where the change performed by the change unit 2080 is incorrect, the incorrect change is modified, and it is therefore possible to display the correct product information on the electronic shelf label 3000.

### Modification Example

The information processing apparatus 2000 of Exemplary Embodiment 7 may include the confirmation reception unit 2180 similarly to the information processing apparatus 2000 of Exemplary Embodiment 6. In this case, for example, the modification reception unit 2200 receives the modification of the relation information that has the content indicating “the association is not correct” and is input to the confirmation reception unit 2180. The product information transmission unit 2100 transmits both 1) the product information the association of which is confirmed as being correct and 2) the modified product information. Here, the non-modified product information among the product information that has the content indicating “the association is not correct” may be the incorrect product information. Thus, the product information transmission unit 2100 does not transmit this product information.

Although the exemplary embodiments of the present invention have been described with reference to the drawings, these exemplary embodiments are examples of the present invention, and the combinations of the exemplary embodiments and various configurations other than the exemplary embodiments may be adopted.

Hereinafter, reference examples are appended.

1. An information processing apparatus comprising:

a product recognition unit recognizing a product from an image on which the product and an electronic shelf label are imaged;

a shelf label recognition unit extracting a shelf label ID of the electronic shelf label from the image, and recognizes a position of the electronic shelf label; and

a determination unit determining whether or not association of product information and the shelf label ID regarding the product and the electronic shelf label being closest to each other within the image matches association of the product information and the shelf label ID indicated by relation information that associates the product information of the product and the shelf label ID, based on the recognized product and shelf label ID.

2. The information processing apparatus according to 1,

wherein the determination unit determines the matching based on the relation information, a position of the recognized product, and a position of the recognized electronic shelf label, by determining whether or not the shelf label ID associated with the product information of the recognized product in the relation information matches the shelf label ID of the electronic shelf label closest to this product, or determining whether or not the product information associated with the recognized shelf label ID in the relation information matches the product information of the product closest to the electronic shelf label having this shelf label ID.

3. The information processing apparatus according to 1 or 2, further comprising a first output unit outputting a determination result performed by the determination unit.

a first output unit that outputs a determination result performed by the determination unit.

4. The information processing apparatus according to any one of 1 to 3, further comprising a change unit changing the shelf label ID associated with the product information in the relation information to the shelf label ID of the electronic shelf label closest to the product of the product information within the image, in a case where the determination unit determines that the association of the product information and the shelf label ID in the relation information does not match the association of the product information and the shelf label ID regarding the product and the electronic shelf label being closest to each other within the image.

5. The information processing apparatus according to 4, further comprising a product information transmission unit transmitting, in a case where the relation information is changed by the change unit, the product information indicated by the changed relation information to the electronic shelf label having the shelf label ID indicated by the changed relation information.

6. The information processing apparatus according to 5, further comprising:

a first instruction unit transmitting to the electronic shelf label an instruction to switch from a first mode to a second mode, information of the product being displayed in the first mode, the shelf label ID being displayed in the second mode; and

a second instruction unit transmitting to the electronic shelf label an instruction to switch from the second mode to the first mode.

7. The information processing apparatus according to 5 or 6, further comprising:

a second output unit outputting the relation information changed by the change unit; and

a confirmation reception unit receiving a confirmation of whether or not association indicated by the relation information is correct,

wherein the product information transmission unit transmits the product information to the electronic shelf label having the shelf label ID indicated by the relation information the association of which is confirmed to be correct.

8. The information processing apparatus according to 5 or 6, further comprising:

a second output unit outputting the relation information changed by the change unit; and

a modification reception unit receiving a modification of the association indicated by the relation information,

wherein the product information transmission unit transmits the product information to the electronic shelf label having the shelf label ID indicated by the modified relation information.

9. A shelf label management system that includes the information processing apparatus according to any one of claims 1 to 8 and an electronic shelf label, wherein the electronic shelf label includes a display unit displaying the product information associated with the shelf label ID of the electronic shelf label.

10. The shelf label management system according to 9, wherein the display unit included in the electronic shelf label displays a plurality of product information in a simultaneous or time-division manner in a case where a plurality of pieces of product information are associated with the shelf label ID of the electronic shelf label.

11. A control method performed by a computer, the method comprising:

a product recognition step of recognizing a product from an image on which the product and an electronic shelf label are imaged;

a shelf label recognition step of extracting a shelf label ID of the electronic shelf label from the image, and recognizing a position of the electronic shelf label; and

a determination step of determining whether or not association of a closest product within the image, and product information and the shelf label ID of the electronic shelf label matches association of product information and a shelf label ID of relation information acquired by associating product information of the product and the shelf label ID based on the recognized product and shelf label ID.

12. The control method according to 11,

wherein, in the determination step, the matching is determined based on the relation information, a position of the recognized product, and a position of the recognized electronic shelf label, by determining whether or not the shelf label ID associated with the product information of the recognized product in the relation information matches the shelf label ID of the electronic shelf label closest to this product, or determining whether or not the product information associated with the recognized shelf label ID in the relation information matches the product information of the product closest to the electronic shelf label having this shelf label ID.

13. The control method according to 11 or 12, further comprising a first output step of outputting a determination result performed in the determination step.

14. The control method according to any one of 11 to 13, further comprising a change step of changing the shelf label ID associated with the product information in predetermined relation information to the shelf label ID of the electronic shelf label closest to the product of the product information within the image, in a case where it is determined that the association of the product information and the shelf label ID in the relation information does not match the association of the product information and the shelf label ID regarding the product and the electronic shelf label being closest to each other within the image.

15. The control method according to 14, further comprising a product information transmission step of transmitting, in a case where the relation information is changed in the change step, the product information indicated by the changed relation information to the electronic shelf label having the shelf label ID indicated by the changed relation information.

16. The control method according to 15, further comprising a first instruction step of transmitting to the electronic shelf label an instruction to switch from a first mode to a second mode, information of the product being displayed in the first mode, the shelf label ID being displayed in the second mode; and

a second instruction step of transmitting to the electronic shelf label an instruction to switch from the second mode to the first mode.

17. The control method according to 15 or 16, further comprising:

a second output step of outputting the relation information changed in the change step; and

a confirmation reception step of receiving a confirmation of whether or not association indicated by the relation information is correct,

wherein, in the product information transmission step, the product information is transmitted to the electronic shelf label having the shelf label ID indicated by the relation information the association of which is confirmed to be correct.

18. The control method according to 15 or 16, further comprising:

a second output step of outputting the relation information changed in the change step; and

a modification reception step of receiving a modification of the association indicated by the relation information,

wherein, in the product information transmission step, the product information is transmitted to the electronic shelf label having the shelf label ID indicated by the modified relation information.

19. A program causing a computer to operate as the information processing apparatus according to any one of 1 to 8.

The present application claims priority based on Japanese Patent Application No. 2014-201365 filed on Sep. 30, 2014, and the entire content thereof is incorporated by reference in the present application.

What is claimed is:

1. An information processing apparatus comprising:
a product recognition unit recognizing a product from an image on which the product and an electronic shelf label are imaged;
a shelf label recognition unit extracting a shelf label ID of the electronic shelf label from the image, and recognizes a position of the electronic shelf label; and
a determination unit determining whether or not association of product information and the shelf label ID regarding the product and the electronic shelf label being closest to each other within the image matches association of the product information and the shelf label ID indicated by relation information that associates the product information of the product and the shelf label ID, based on the recognized product and shelf label ID.

2. The information processing apparatus according to claim 1,
wherein the determination unit determines the matching based on the relation information, a position of the recognized product, and a position of the recognized electronic shelf label, by determining whether or not the shelf label ID associated with the product information of the recognized product in the relation information matches the shelf label ID of the electronic shelf label closest to this product, or determining whether or not the product information associated with the recognized shelf label ID in the relation information matches the product information of the product closest to the electronic shelf label having this shelf label ID.

3. The information processing apparatus according to claim 1, further comprising a first output unit outputting a determination result performed by the determination unit.

4. The information processing apparatus according to claim 1, further comprising a change unit changing the shelf label ID associated with the product information in the relation information to the shelf label ID of the electronic shelf label closest to the product of the product information within the image, in a case where the determination unit determines that the association of the product information and the shelf label ID in the relation information does not match the association of the product information and the shelf label ID regarding the product and the electronic shelf label being closest to each other within the image.

5. The information processing apparatus according to claim 4, further comprising a product information transmission unit transmitting, in a case where the relation information is changed by the change unit, the product information indicated by the changed relation information to the electronic shelf label having the shelf label ID indicated by the changed relation information.

6. The information processing apparatus according to claim 5, further comprising:
a first instruction unit transmitting to the electronic shelf label an instruction to switch from a first mode to a second mode, information of the product being displayed in the first mode, the shelf label ID being displayed in the second mode; and
a second instruction unit transmitting to the electronic shelf label an instruction to switch from the second mode to the first mode.

7. The information processing apparatus according to claim 5, further comprising:
a second output unit outputting the relation information changed by the change unit; and
a confirmation reception unit receiving a confirmation of whether or not association indicated by the relation information is correct,
wherein the product information transmission unit transmits the product information to the electronic shelf label having the shelf label ID indicated by the relation information the association of which is confirmed to be correct.

8. The information processing apparatus according to claim 5, further comprising:
a second output unit outputting the relation information changed by the change unit; and
a modification reception unit receiving a modification of the association indicated by the relation information,
wherein the product information transmission unit transmits the product information to the electronic shelf label having the shelf label ID indicated by the modified relation information.

9. A shelf label management system that includes the information processing apparatus according to claim 1 and an electronic shelf label, wherein the electronic shelf label includes a display unit displaying the product information associated with the shelf label ID of the electronic shelf label.

10. The shelf label management system according to claim 9, wherein the display unit included in the electronic shelf label displays a plurality of product information in a simultaneous or time-division manner in a case where a plurality of pieces of product information are associated with the shelf label ID of the electronic shelf label.

11. A control method performed by a computer, the method comprising:
recognizing a product from an image on which the product and an electronic shelf label are imaged;
extracting a shelf label ID of the electronic shelf label from the image, and recognizing a position of the electronic shelf label; and
determining whether or not association of a closest product within the image, and product information and the shelf label ID of the electronic shelf label matches association of product information and a shelf label ID of relation information acquired by associating product information of the product and the shelf label ID based on the recognized product and shelf label ID.

12. A non-transitory computer readable storage medium storing a program causing a computer to operate as the information processing apparatus according to claim 1.
